(19) United States
(12) Patent Application Publication
(10) Pub. No.: US 2015/0079551 A1
(43) Pub. Date: Mar. 19, 2015

(54) SYSTEM FOR PLANNING MEALS

(71) Applicant: Mary Egan, Mercer Island, WA (US)

(72) Inventor: Mary Egan, Mercer Island, WA (US)

(21) Appl. No.: 14/272,994

(22) Filed: May 8, 2014

Related U.S. Application Data
(60) Provisional application No. 61/878,290, filed on Sep. 16, 2013.

(51) Int. Cl. G09B 19/00; G09B 5/02

(52) U.S. Cl. CPC G09B 19/0092; G09B 5/02
USPC 434/127

(57) ABSTRACT

Some embodiments of the invention provide a system which creates and delivers a meal plan to a user. The meal plan may be customized to suit the user, by drawing from recipes in the user's personal collection, and by enabling the user to specify goals relating to nutrition, budget, preparation time, etc. Once approved by the user, a meal plan may serve as a basis for a shopping list which includes items called for by recipes in the meal plan, and/or other items. The shopping list may form the basis for a delivery order submitted to a grocery provider, if the user so desires. As such, embodiments of the invention may enable the user to avoid expending the time and mental energy conventionally associated with planning meals and shopping for their ingredients.

### RELATED APPLICATION

This application claims priority under 35 U.S.C. §119(e) to U.S. Provisional Patent Application Ser. No. 61/878,290, filed Sep. 16, 2013, entitled “SYSTEM FOR PLANNING MEALS”, the entirety of which is incorporated herein by reference.

### BACKGROUND

Cooking-related websites exist which make recipes available to users in electronic form. Often, these sites allow a user to search recipes according to specific criteria (e.g., by ingredient, type of cuisine, etc.), and to create a personal collection of recipes. Some sites allow a user to develop a menu based on recipes in his/her collection. In addition, some websites enable a user to generate a shopping list from one or more recipes.

### SUMMARY OF INVENTION

The inventor has appreciated that the main obstacle preventing many families from enjoying home-cooked dinners more frequently is not the approximately thirty minutes required each day to prepare and cook the meal. Rather, the main obstacle is the amount of time needed to plan the meal and to gather the ingredients for it. In this respect, many people enjoy cooking and collecting recipes, and indeed many homes have stacks of recipes set aside on a shelf. However, most people have neither the time nor the inclination to sit down regularly and plan what the family is going to eat over a given period (e.g., the following week), make a grocery list, travel to the grocery store, pick up the groceries, and transport them home. Often, one's plan to sit down at the start of a weekend to plan the family's meals for the coming week gets sidetracked by other tasks, as American families are increasingly as busy during the weekend as during the week. By the end of the weekend, often no meal planning has occurred, let alone shopping to obtain ingredients. As a result, American families increasingly opt for processed, pre-prepared dishes, which has led to increasing obesity rates and health problems.

Accordingly, some embodiments of the invention provide a system which creates and delivers a “meal plan” (e.g., a menu, including meals, such as dinners, to occur over a particular period, such as over the coming week) to a user. In accordance with some embodiments of the invention, a meal plan may be customized to suit the user and/or other individuals (e.g., the user's family, although embodiments of the invention are not limited to being used with any particular group of individuals), and in this respect may draw from recipes previously collected by the user, may be designed to enable the user to achieve certain goals (e.g., nutritional goals, budget goals, goals relating to how often certain types of dishes are served, goals for how often a “new” recipe that a user has not made before should appear in a meal plan, etc.), and may be easily modified by the user to suit his tastes and preferences. As such, some embodiments of the invention may enable the user to avoid expending the time and mental energy conventionally associated with devising a meal plan and getting the ingredients.

Further, some embodiments of the invention may enable a user to generate a shopping list from a generated meal plan. The shopping list may include ingredients called for by recipes included in the meal plan, and/or other items. For example, a shopping list may take into account a user's expressed preferences regarding certain items which are to be kept on hand (e.g., salt, pepper, olive oil, etc.), and/or items for meals not included in the meal plan (e.g., if the meal plan accounts only for dinners, the grocery list may include items for breakfast, lunch, snacks, etc.). Once the user approves the shopping list, it may, for example, form the basis for an order that may be automatically submitted to a grocery provider so that the items may be delivered to the user at a specified time(s). An order may, for example, be customized to, suit the user's expressed preferences, such as by specifying only organic produce, products having a particular brand name, etc. As such, some embodiments of the invention may enable the user to avoid expending the time and energy typically associated with grocery shopping.

The foregoing is a non-limiting summary of only some aspects of the invention described in further detail below. Some embodiments of the invention are defined by the claims set forth herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a representative screen interface provided by a system for generating meal plans based at least in part on information supplied by a user;

FIG. 2 is a representative screen interface which enables a user to outline certain goals for planning meals, in accordance with some embodiments of the invention;

FIG. 3 is a representative screen interface enabling a user to specify nutrition goals and related information, in accordance with some embodiments of the invention;

FIG. 4 is a representative screen interface enabling a user to specify center of plate content and format, in accordance with some embodiments of the invention;

FIG. 5 is a representative screen interface enabling a user to specify various items to be included in a meal, in accordance with some embodiments of the invention;

FIG. 6 is a representative screen interface enabling a user to specify an amount of time and money to be devoted to individual meals, in accordance with some embodiments of the invention;

FIG. 7 is a representative screen interface enabling a user to construct a library of recipes, in accordance with some embodiments of the invention;

FIG. 8 is a representative screen interface enabling a user to view and select recipes in his/her personal collection, in accordance with some embodiments of the invention;

FIG. 9 is a representative screen interface enabling a user to view and select recipes in his/her personal collection, in accordance with some embodiments of the invention;

FIG. 10 is a representative screen interface enabling a user to view a particular recipe in the collection, in accordance with some embodiments of the invention;

FIG. 11 is a representative screen interface enabling a user to view set meal-related preferences, in accordance with some embodiments of the invention;

FIG. 12 is a representative screen interface enabling a user to view specify items to exclude from a grocery list, in accordance with some embodiments of the invention;

FIG. 13 is a representative screen interface enabling a user to specify items to include in a grocery list, in accordance with some embodiments of the invention;

FIG. 14 is a block diagram depicting components of system for automatically generating meal plans based at least in part on information provided by a user, in accordance with some embodiments of the invention;

FIG. 15 is a flow chart of a process for developing a mean plan based at least in part on information supplied by a user;

FIG. 16 is a representative screen interface enabling a user to view and/or edit an automatically generated meal plan, in accordance with some embodiments of the invention;

FIG. 17 is a representative screen interface enabling a user to view and/or edit a grocery list generated for a meal plan, in accordance with some embodiments of the invention;

FIG. 18 is a representative screen interface which enables a user to resolve conflicts relating to generation of a meal plan, in accordance with some embodiments of the invention;

FIG. 19 is a block diagram depicting a representative computer system which may be employed to implement aspects of the invention; and

FIG. 20 is a block diagram depicting a representative storage medium for storing instructions which, when executed, implement aspects of the invention.

### DETAILED DESCRIPTION

Some embodiments of the invention provide systems and methods which enable a user to enjoy the benefits of home-cooked meals without having to expend the time and energy associated with planning those meals or shopping for their ingredients. In this respect, the inventor has recognized that while many people enjoy cooking and collecting recipes, many also have neither the time nor the inclination to sit down and put together a plan for upcoming meals, make a grocery list, travel to the grocery store, transport the groceries home, etc. As a result, families often are left consuming processed, pre-prepared dishes, leading to increasing obesity rates and health problems.

Accordingly, some embodiments of the invention automatically generate a meal plan for a user. A meal plan may be drawn from recipes in the user's personal recipe collection, and be designed to enable the user to achieve goals relating to nutrition, budget, and how often certain types of dishes are consumed. As such, a meal plan generated for a user may be customized to suit the needs of the user. The meal plan may be delivered to the user in a manner, and at a time, which is specified by him, so that the user may have time to review it and modify it if necessary. (The pronouns “he,” “him” and “his” are used to refer to the user throughout this document for brevity, although it should be appreciated that embodiments of the invention are not limited to use by any specific gender.)

Some embodiments of the invention provide for the automatic generation of a shopping list from a user's meal plan. The shopping list may include ingredients called for by recipes included in the meal plan, and/or other items, such as certain items which the user has expressed a desire to always keep on hand, items for meals which are not accounted for in the meal plan, etc. Once the user approves the shopping list, it may serve as a basis for a delivery order which is placed with a grocery provider, so that the user need not shop for groceries. The benefits a user may enjoy from a system implemented in accordance with embodiments of the invention are numerous, including being able to enjoy home-cooked meals without having to expend the time and/or energy conventionally associated with planning meals, and/or shopping for ingredients called for by recipes for those meals.

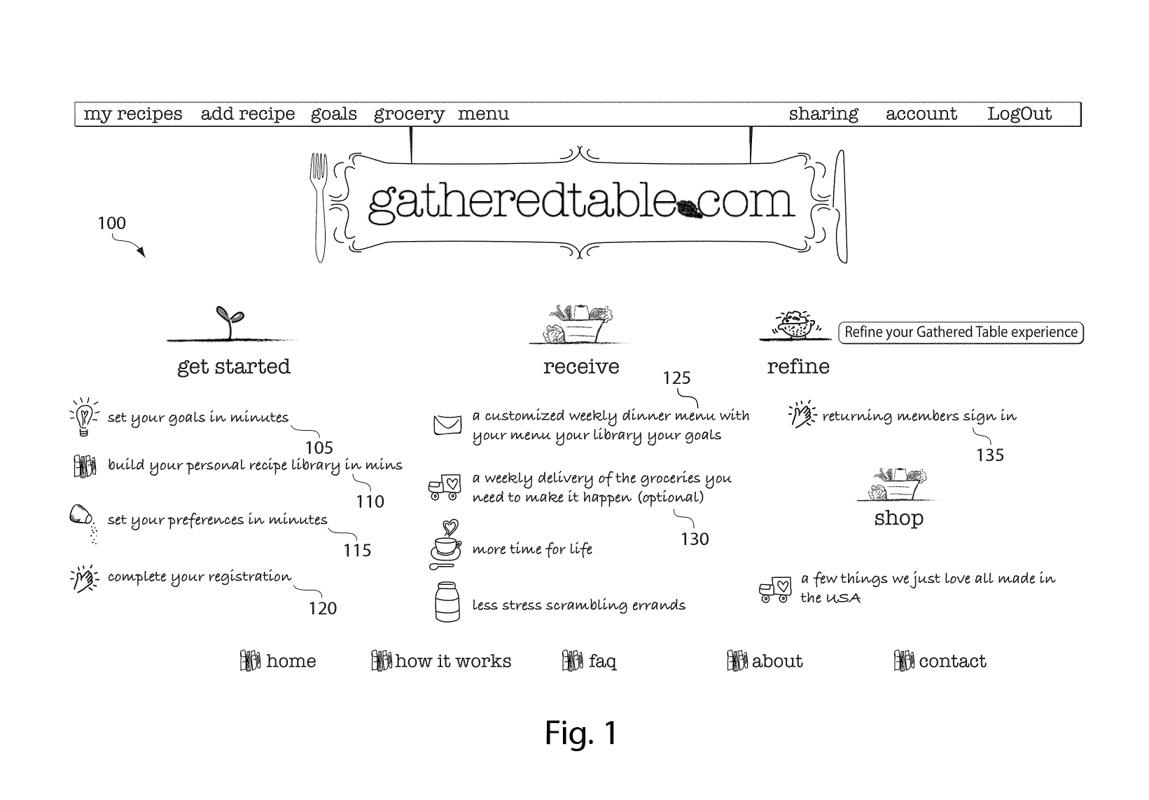

In some embodiments of the invention, the information from which a meal plan is generated may include information which is provided by the user. This information may, for example, include the user's goals and preferences, a library of recipes assembled by the user, and/or other information provided by the user. FIGS. 1-13, described below, depict representative screen interfaces which enable a user to supply information upon which a meal plan may be based, such as desired attributes and/or characteristics of various meals included in the meal plan. The types of information which a user may supply via the representative screen interfaces shown in FIGS. 1-13 are described below.

FIG. 1 depicts a representative screen interface 100 which provides a user with access to tools to provide various types of information. Specifically, representative screen interface 100 includes link 105, which provides access to tools that enable the user to specify his goals (e.g., nutritional goals, budget goals, and/or other considerations), link 110, which provides access to tools that allow the user to build or modify a personal recipe library, link 115, which provides access to tools that allow the user to specify meal plan-related preferences, and link 120, which enables the user to complete a registration process.

It should be appreciated that the references herein to “links” used to navigate the system described are intended to merely be illustrative, as embodiments of the invention are not limited to being implemented using hypertext, or any other Internet- or web-based technologies. For example, embodiments of the invention may be implemented as a stand-alone software application, which may, for example, execute on a user's computer (e.g., as an “app” which executes on a mobile device, such as a smartphone, tablet, etc., or one or more programs that execute on a desktop computer), and/or as a network-based application which does not employ hypertext. Any suitable technology or technologies may be employed. Similarly, the references herein to links being “clicked” are also intended to be merely illustrative, as any suitable form of input may be provided by a user to navigate the system described, and/or specify information upon which a meal plan is based, which forms of input include but are not limited to the click of a mouse, stylus or other manual implement. For example, user input may be provided via touch, voice, and/or in any other form(s), as embodiments of the invention are not limited to any particular mode of implementation.

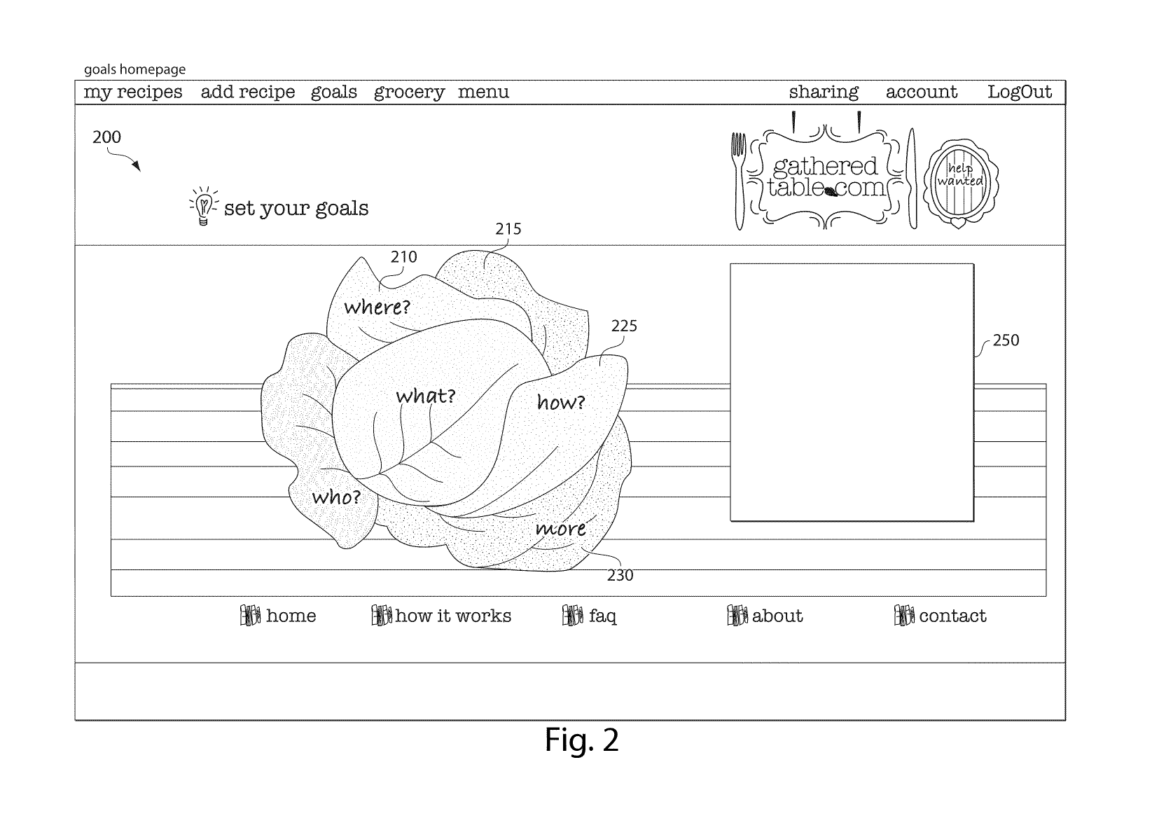

FIG. 2 depicts a representative screen interface 200 which may be displayed to a user who clicks link 105 (FIG. 1). Representative screen interface 200 includes a set of links which are stylized as a head of lettuce, and a display area 250 stylized as a chalk board. In the example shown, clicking on the “who?” link 205 causes the question “I plan to cook for ______ people/night” be shown in display area 250, prompting the user to supply input (e.g., typewritten input) in display area 250 to specify the number of people a meal plan should accommodate. In some embodiments, a default number of four people is initially shown, and may be modified by the user, although embodiments of the invention are not limited to such an implementation.

Clicking on the “where?” link 210 causes the question “I live in zip code ______” to be shown in display area 250, prompting the user to specify his zip code. In some embodiments, this information may be used to determine whether grocery delivery is possible. Of course, some embodiments enable users to have meal plans generated even if they live in a geographic location where grocery delivery is unavailable. These embodiments may, for example, enable the user to print an automatically generated grocery list to take the list to a grocery store.

Clicking on the “when?” link 215 causes questions including how many nights a week the user plans to cook, at what time should the meal plan be delivered to the user, to be shown in display area 250, prompting the user to supply this information. If grocery delivery is available to the user, the user may be prompted to specify when grocery delivery should occur.

In the example shown, clicking on the “why?” link 225 causes a screen interface to be displayed which provides information on the benefits of homemade meals, and invites the user to share his/her experiences with meal planning with others.

In the example shown, clicking on the “more” link 230 causes an input facility to be shown in display area 250 which enables the user to supply information used to identify the types of recipes which are to be included, or not included, in the user's meal plan. Any of numerous types of information may be supplied. For example, some embodiments may enable the user to specify one or more recipe selection criteria (e.g., filters) which are to be applied in selecting recipes for inclusion in a meal plan. Any of numerous criteria may be specified by the user. In one example, the user may specify one or more food preparation techniques which they favor, or do not favor, so that recipes which call for this technique are included, or not included, in his/her meal plan. For example, the user may specify that any meal plan generated for him/her should not include any recipes made using the “stir fry” preparation technique.

In another example, the user may designate a specified time period with a label (e.g., the user may designate the time period between March 21 and June 21 as “spring,” the time period between June 22 and September 10 as “summer,” etc.) and indicate that a meal plan which spans at least a portion of the specified time period should include, or not include, recipes having the label. For example, the user may specify that any meal plan generated for the time period between March 21 and June 21 should include at least one recipe having the label “spring” per week. Recipes having the label “spring” may, for example, call for ingredients in season during the spring season.

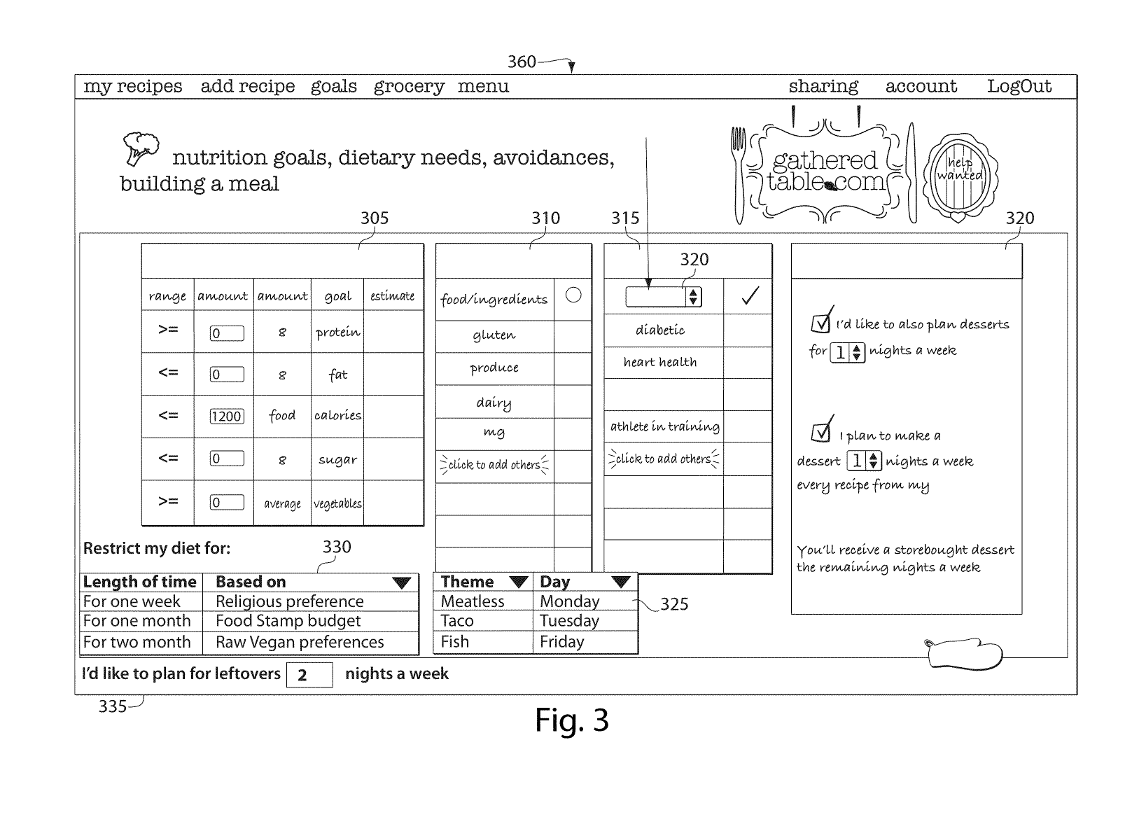

Further, some embodiments of the invention may allow plural selection criteria to be applied in choosing recipes for inclusion in a meal plan. Using the examples given immediately above to illustrate, the user may specify that any meal plan generated for the time period between March 21 and June 21 should omit “stir fry” recipes, but also include at least one recipe labeled “spring” each week. FIG. 3 is a representative screen interface 300 which is shown when the user clicks on the “what?” link 220 on representative screen interface 200 (FIG. 2). Representative screen interface 300 includes tools which allow the user to supply input relating to nutrition goals, dietary needs, avoidances and considerations for building meals. These tools include facility 305, which allows the user to specify nutrition goals per person per dinner, facility 310, which allows the user to specify types of foods or ingredients to avoid, facility 315, which allows the user to specify dietary considerations, facility 320, which allows the user to provide information on desserts, facility 325, which enables the user to specify “theme nights,” facility 330, which allows the user to specify time-bounded dietary restrictions, and facility 335, which allows the user to specify that a meal plan should include one or more meals of leftovers. The information which may be supplied using facilities 305, 310, 315 320, 325, 330 and 335 is to described in further detail below. It should be appreciated that some embodiments of the invention may provide facilities that enable a user to specify other types of information, and that some embodiments may not provide access to all of the facilities shown in representative screen interface 300.

Using facility 305, a user may specify target amounts of protein, fat, calories, sugar and servings of vegetables in each meal. Of course, some embodiments of the invention may enable a user to specify target amounts of nutrients other than those shown. In some embodiments of the invention, a template may define “standard” amounts of certain nutrients. For example, a user may not have a target protein intake in mind, and so an amount may be suggested, such as an amount which is based on nutritional guidelines.

Using facility 310, a user may select ingredients that are to be avoided in recipes comprising a meal plan. These ingredients may, for example, include allergens or ingredients or foods which the user wishes to avoid.

Facility 315 allows a user to categorize his family according to types of food it generally eats (e.g., omnivore, vegetarian, pescetarian, vegan, etc.). In addition, the user may indicate overall dietary considerations, such as whether family members are diabetic, concerned about heart health, eat a kosher diet, are athletes in training, etc. Embodiments of the invention may enable the user to specify any type of diet and/or dietary considerations, including those not specifically shown in representative screen interface 300.

Facility 320 enables the user to indicate how many nights per week a meal plan should include a dessert, and of these, how many nights per week a store-bought dessert should be served, and how many nights a homemade dessert is to be prepared.

Facility 325 enables the user to specify that certain nights during the week are to be “theme nights.” The user may specify, for example, that a recipe having a certain theme (e.g., “meatless”) should be included in the meal plan for a particular night (e.g., Monday night). A user may select from any suitable number and types of themes, and have a selected theme be applied to any suitable number of meals, as embodiments of the invention are not limited in this respect.

Facility 330 enables the user to specify time-bounded dietary restrictions. For example, the user may specify that during a given time period (e.g., for one week, one month, two months, etc.), he wishes to impose one or more restrictions on his/her diet. For example, the user may specify that he wishes to eat kosher for a particular week. As such, embodiments of the invention may include only kosher recipes in the user's meal plan for the specified week. As another example, the user may specify that he wishes to live on a “food stamp budget” for a month, so that a meal plan for the user includes only meals that can be prepared for less than the amount provided to food stamp recipients during that period, perhaps enabling the user to donate any amounts saved to charity. A user may specify that any suitable restriction(s) may be applied, for any suitable time period(s).

Facility 335 enables the user to specify that a certain number of meals in a given time period (e.g., a week, month, etc.) comprise leftovers from previously prepared meals. In some embodiments of the invention, an indication that a certain number of meals in a time period should comprise leftovers causes the number of servings included in one or more other meals during that time period to be increased. For example, if a meal plan includes five nights worth of meals for four people, and the user indicates that two nights of meals that week should be leftovers, then the total number of servings in the remaining three nights that week may be increased so that an additional eight servings are created during those nights, to feed the four people for the two nights that leftovers are to be served. The number of servings in the remaining three nights may be increased in any suitable fashion, in a manner which is determined automatically without the user's input or based on input provided by the user. For example, the user may identify a single meal as the source of all of the leftovers (so that the recipe for that meal is modified to accommodate preparing an additional eight servings), or two meals may be automatically identified as the source of the leftovers (so that, for example, the recipe for each of those two meals is modified to accommodate preparing an additional four servings). If the source of the leftovers is identified automatically, identification may be based on any suitable criteria. For example, identification may be based on the cost per meal (so that, for example, the least expensive recipes are selected to be the source of leftovers, rather than more expensive meals), expressed user preferences (so that, for example, meals which include the user's favorite ingredients are selected to be the source of leftovers), and/or any other suitable criteria.

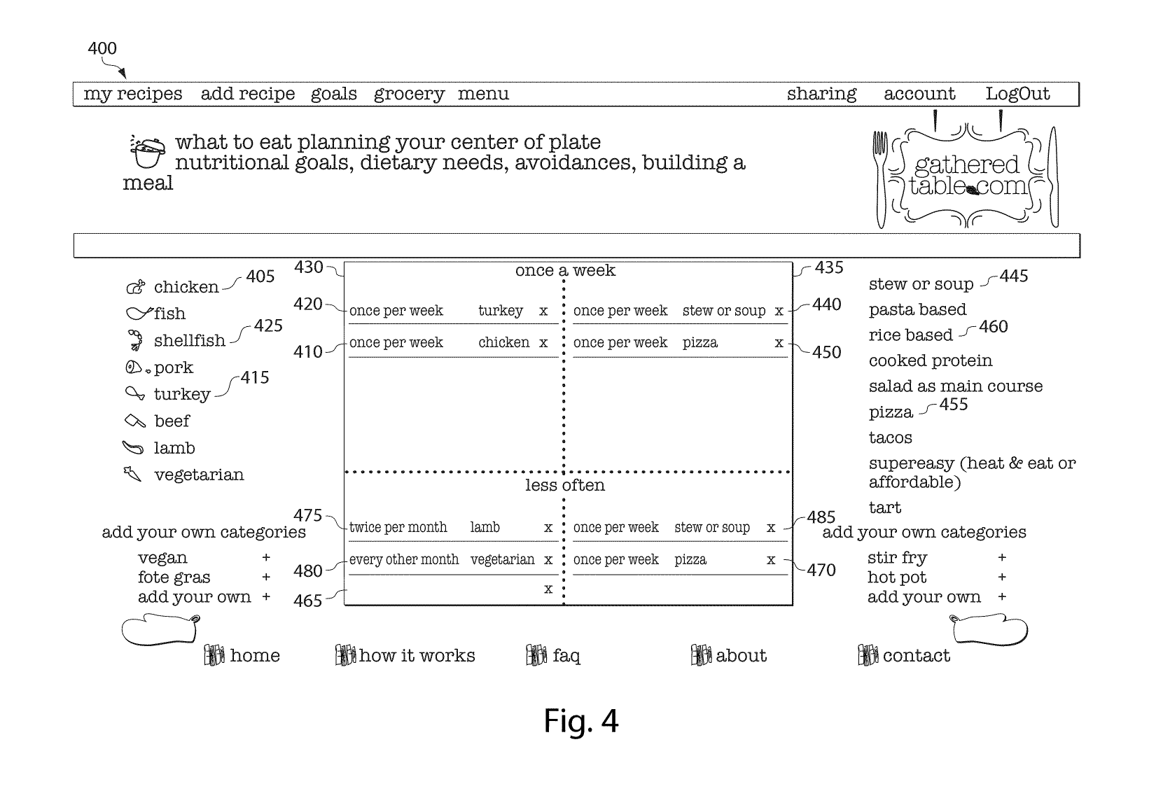

It should be appreciated that nutritional goals, dietary needs, avoidances and meal-building considerations may be specified by the user at any suitable juncture, and not just the first time the user desires a meal plan to be generated. For example, as the user's dietary needs change, he may return to representative screen interface 300 to provide updated information, which may then be considered in generating subsequent meal plans. FIG. 4 depicts a representative screen interface 400 which enables a user to specify “center of plate” content and format, acknowledging that many users think of meals in terms of not only the main meal component (e.g., a protein, for omnivores) at the center of the plate, but also how that component is to be prepared. Some embodiments of the invention recognize that both considerations are important, and allow the user to specify both.

In the example shown (which is based on an “omnivore” diet), a user may select from among different proteins around which a corresponding meal should be constructed. As an example, clicking link 405 (“chicken”) enables the user to indicate, as shown in display area 430, that chicken is to be included in one meal per week. In the example shown, a user may increment a number of meals in which a particular protein is included by clicking on a corresponding link. Thus, representative screen interface 400 reflects that the user has clicked on link 415 (“turkey”) twice, causing an indication that two meals per week are to include turkey to be shown at display area 430. Similarly, by clicking on link 425 (“shellfish”), the user may indicate that shellfish is to be included in one or more meals per week, as shown in display area 430.

Display area 435 shows the user's selections regarding the “center of plate” format for meals. In the example shown, the user has clicked on link 445 (“stew or soup”) to indicate that a protein shown in display area 430 is to be included in a stew or soup in one meal per week (as shown at 440), and has clicked on link 455 to indicate that a protein shown in display area 430 is to be included in a pizza dish (as shown at 450) in one meal per week. The user may add a specified meal format by clicking on an associated link. For example, the user may indicate that a rice-based dish is to comprise the center of plate in one meal per week by clicking link 460.

Representative screen interface 400 also enables a user to specify that proteins and/or formats are to be included in meals less often than weekly. In the example shown, the user has indicated that lamb is to be included in meals twice per month (as shown at 475), that a vegetarian dish is to comprise the center of plate content every other month (as shown at 480), and that a tart is to comprise the center of plate format twice per month (as shown at 485).

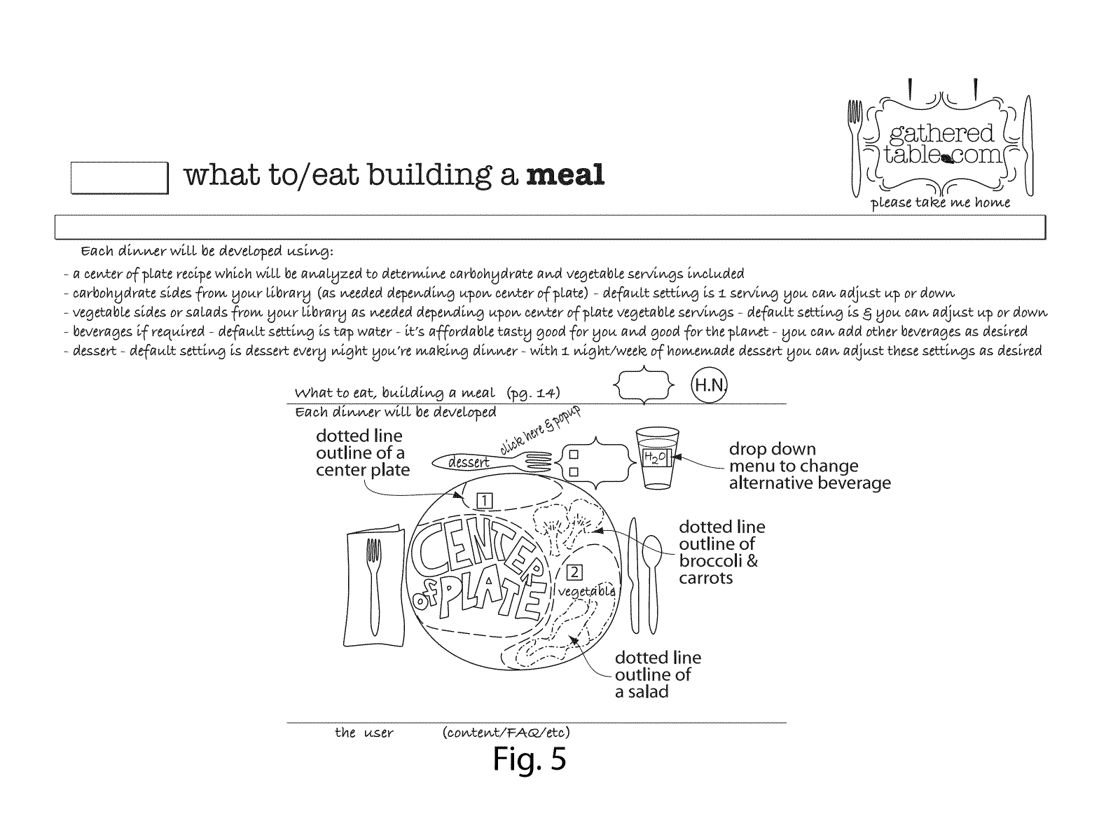

FIG. 5 depicts representative screen interface 500, which allows a user to specify the elements of a typical meal. In the example shown, the user may indicate whether and how many carbohydrate servings are to be included, whether and how many vegetable servings are to be included, a type of beverage, and whether and what type of dessert is to be included. In some embodiments of the invention, default values for each selection may be shown, prompting the user to change the default values if desired. For example, a default value of one carbohydrate serving, two vegetable servings, tap water, and a single dessert with each meal may be indicated. Of course, embodiments of the invention need not specify default values, and may be implemented in any suitable manner.

In some embodiments of the invention, the number of servings in a meal may be automatically adjusted based on the other components of the meal. For example, if the user specifies that two vegetable servings are to be included in each meal, and the center of plate component includes a vegetable (e.g., is a casserole with vegetables included), only one other vegetable may be included in the meal as a side serving. In addition, some embodiments may allow the user to modify a meal that is automatically adjusted in this fashion. For example, if the user indicates that each meal is to include one carbohydrate serving, and a particular meal is lamb stew with potatoes, so that no separate carbohydrate side serving would be included in the meal, the user may override this to include that a loaf of French bread is to be served with the meal.

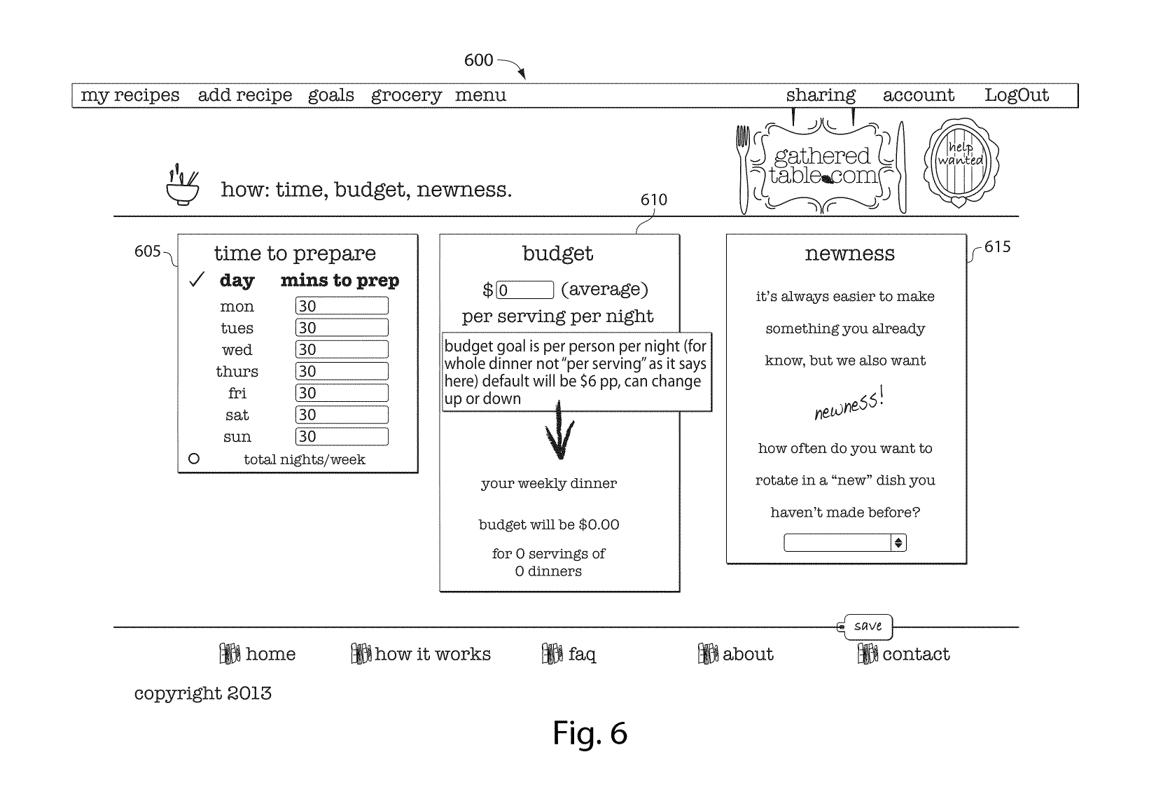

Representative screen interface 600, shown in FIG. 6, enables the user to specify how much time he has to prepare meals each night during the week, a target budget per person per night for weekly meals, and a frequency with which a new recipe (e.g., which the user has not prepared before) is included in a weekly meal plan.

In the example shown, facility 605 enables the user to select which days of the week he plans to cook. For example, for a user who plans to cook five nights per week, facility 605 enables the user to indicate which five nights of the week he intends to cook, and how much time he plans to devote to cooking each of those nights. As discussed in further detail below, the user's specification of a certain amount of time to devote to meal preparation each night may determine, at least in part, the recipes which are selected for use in the meal plan that night. For example, if the user indicates that he has twenty minutes to devote to meal preparation on Monday night, then the recipe included in the meal plan for Monday night would be selected from those which have total preparation times that do not exceed twenty minutes.

Some embodiments of the invention enable the user to specify how much time they have each night to devote to “hands on” tasks (i.e., “hands-on time”), when they are actually doing something, such as chopping, washing, etc., as opposed to “total elapsed time,” which is the total time needed to prepare the meal, including cooking time. For example, preparation of a roast chicken may require ten minutes of hands-on time, and a total elapsed time of ninety minutes. As such, a roast chicken recipe may be included on a user's meal plan for a given day if they have specified that they have at least ten minutes of hands-on time and ninety minutes of total elapsed time on that day.

Facility 610 enables the user to specify an average budget goal per person per meal for a given time period (e.g., week). A specified budget goal may determine, at least in part, which recipes are selected for inclusion in the meal plan. In some embodiments, the generation of a meal plan to suit a user's budget goals may employ grocery pricing information (e.g., provided by a grocery supplier). As an example, given a user's goal of $6.00 per person per meal, for meals for four people for five nights (i.e., a total meal budget of $120), pricing information may be analyzed to arrive at a meal plan which does not exceed the total budget. In some embodiments, some meals included in a meal plan may exceed a pro rata budget goal, so long as other meals in the meal plan compensate for any overage. Continuing with the above example to illustrate, a goal of $6.00 per person per meal, for a meal for four people, yields a daily budget goal of $24. However, a meal costing more than $24 may be scheduled for one night during the week so long as the other four meals that week are inexpensive enough to yield a total meal cost of $120.

Facility 615 enables the user to specify a frequency with which “new” recipes are included in meal plans. This functionality enables a user to have generated meal plans be based primarily on recipes in his personal collection, including drawing from a queue of new dishes over time, which the user has added to their library as new dishes they'd like to try. If the user enjoys a new recipe included in a meal plan, he may identify the dish as a favorite (e.g., using functionality described further below). A “new” recipe may be selected for inclusion in a user's meal plan in any suitable fashion, using any suitable information. For example, in some embodiments of the invention, a new recipe may be suggested to a user based on similarities to other recipes in the user's personal collection. For example, if the recipes in the user's personal collection indicate an affinity for spicy dishes, then a new recipe might be suggested to the user based on the recipe's having spicy ingredients.

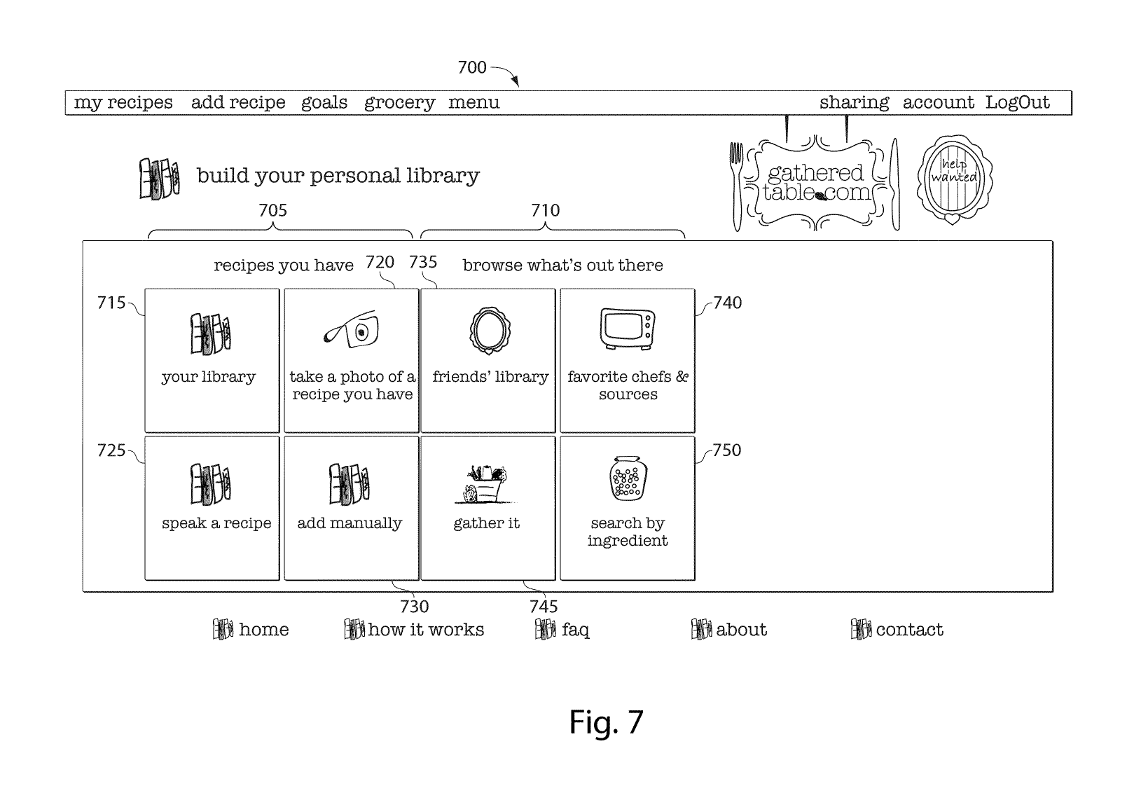

FIG. 7 depicts representative screen interface 700, which enables a user to create and manage a personal recipe collection. By clicking one of the links shown in display area 705, a user may review his/her collection of recipes and/or add recipes to that collection. For example, in the representative screen interface shown, clicking on link 715 provides access to the user's personal collection of recipes, clicking on link 720 causes an interface to be displayed which allows the user to add a recipe to his/her personal collection by taking a photograph of it, clicking on link 725 allows the user to add a recipe to his/her collection via voice input, and clicking on link 730 causes a screen interface to be shown which enables the user to type a recipe.

By clicking on one of the links shown in display area 710, the user may browse various sources for recipes to add to his personal recipe collection. For example, in the representative screen interface shown, clicking link 735 causes an interface to be displayed which displays the recipe collections of the user's “friends” (which may be identified in any suitable manner), clicking link 740 causes an interface to be displayed which shows recipes of the user's favorite chefs, clicking link 745 provides access to tools which allow the user to get recipes from other sources, and clicking link 750 provides access to tools which enable the user to search for recipes by ingredient.

The inventor has appreciated that some users may not have pre-established personal recipe collections, or be willing to invest the time needed to transfer a personal recipe collection to storage. As such, some embodiments of the invention provide users with access to “starter” recipe libraries. Different starter libraries may be made available for different diets. For example, some embodiments may provide one starter library for omnivores, another for vegetarians, another for vegans, etc. It should be appreciated that providing starter libraries may allow a user to “try out” the system to see whether it meets his needs before having to invest the time needed to import his own personal collection of recipes.

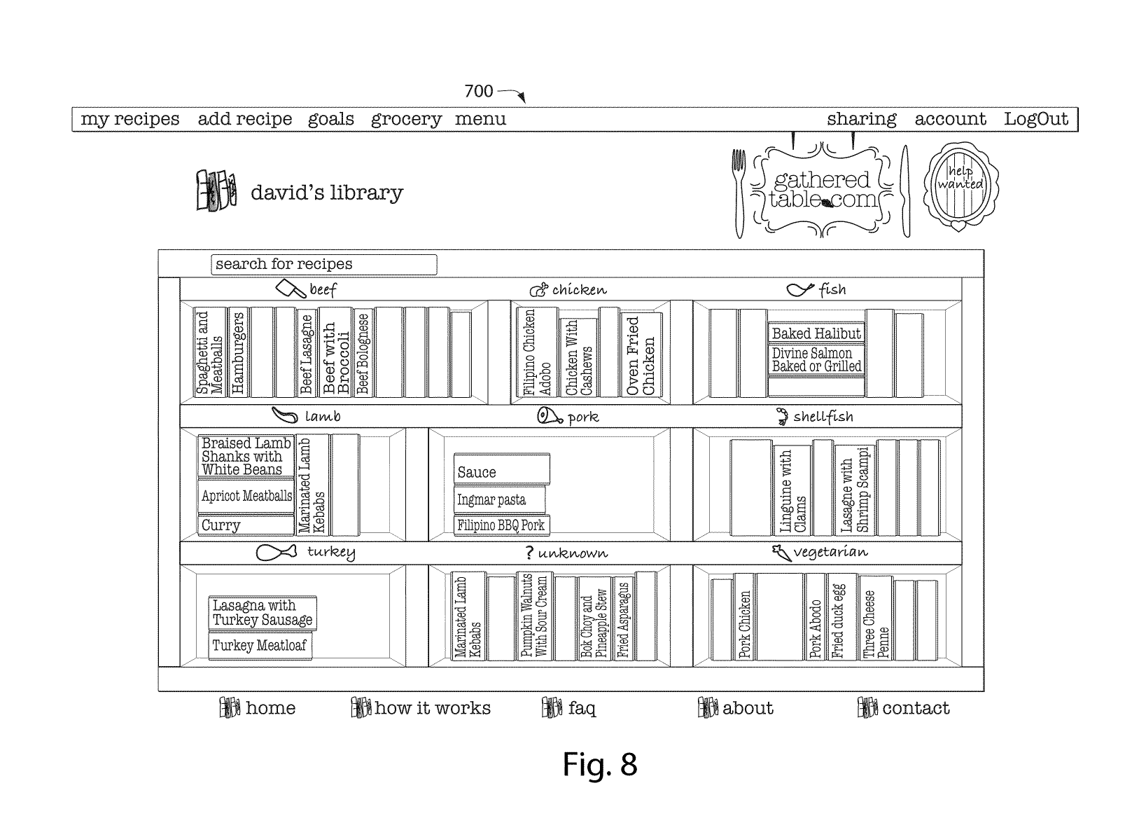

FIG. 8 depicts representative screen interface 800, which displays the recipes in a user's personal collection. Recipes in a personal collection may be organized and/or displayed in any suitable fashion. In the example shown in FIG. 8, recipes are organized according to user-specified “center of plate” content (e.g., specified via screen interface 400, shown in FIG. 4). Thus, display area 805 shows “beef” recipes, display area 810 shows “chicken” recipes, and so on. Some embodiments may allow users to identify certain recipes are favorites (e.g., by adding “stars” and/or other indicators), and/or specify an ethnicity for certain recipes (e.g., using a That flag to indicate That recipes, and/or using other indicators).

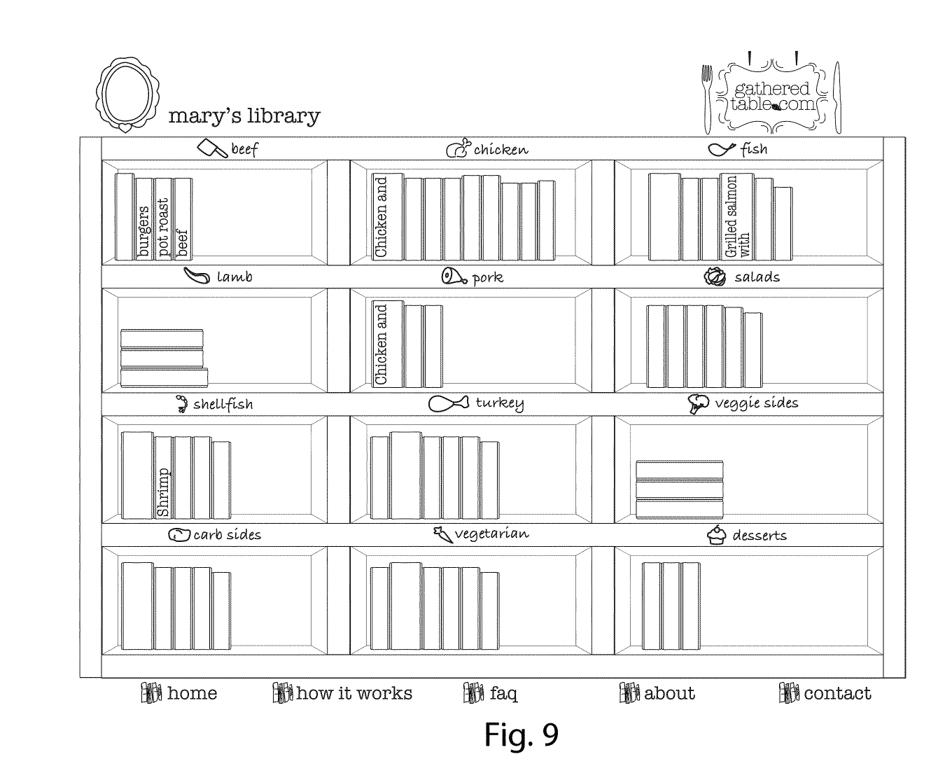

Representative screen interface 900, shown in FIG. 9, provides an alternative view of the user's personal recipe collection. The example shown includes additional categories to those included in representative screen interface 800 (FIG. 8), including categories for side dishes (e.g., “veggie sides,” “carb sides”) and “salads.” Any suitable categories may be displayed, using any suitable categorization scheme, as embodiments of the invention are not limited in this respect.

Some embodiments of the invention may enable users to share their personal recipe collection with other users. For example, some embodiments may enable users to share recipes with all individuals designated as “friends” of the user, or with one or more specific individuals. Some embodiments which allow users to share their recipes may recognize those users whose recipes are added most often to other users' libraries (e.g., by awarding the originating user a “trophy” for display in his personal library).

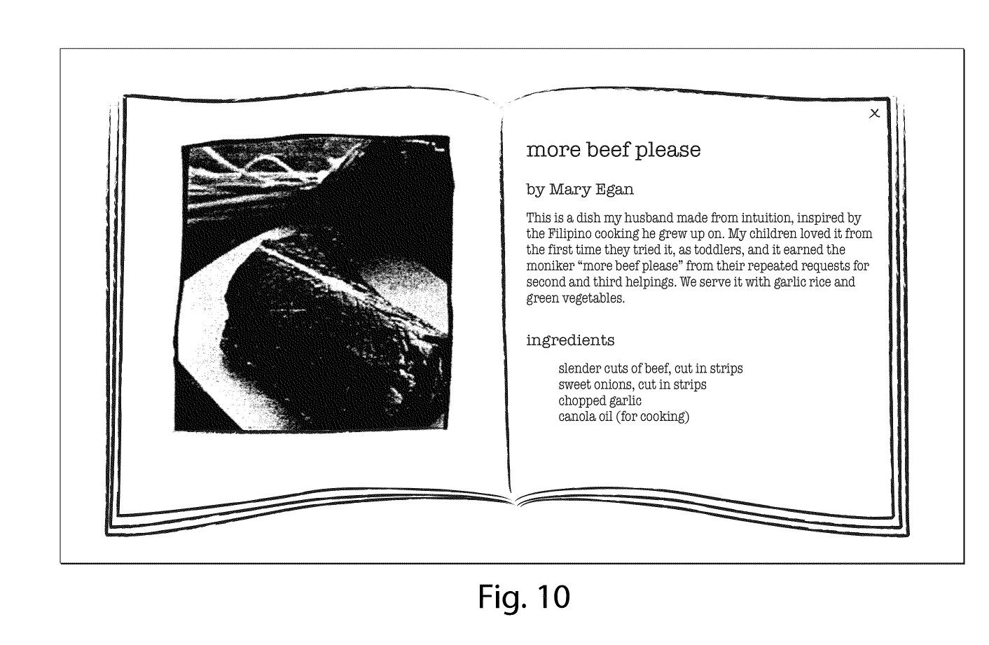

Representative screen interface 1000, shown in FIG. 10, enables a user to view and edit a particular recipe in his collection. Representative screen interface 1000 may enable the user to edit such information as the recipe name, ingredients and directions, the recipe's yield (e.g., number of servings), preparation time required (e.g., hands-on time and total elapsed time). In addition, representative screen interface 1000 may allow the user to manage (e.g., add, modify, etc.) a photograph displayed with the recipe.

Some embodiments of the invention may enable a user to indicate how frequently a particular recipe is included in generated meal plans (e.g., more than once a month, every other month, every 3 months, on special occasions, and/or at any other suitable frequency). Representative screen interface 1000 enables the user to specify this “rotation frequency,” as well as the capability to indicate that a particular recipe is new to him, such that he does not yet know how frequently it should be included. In this respect, some embodiments of the invention may prompt the user to indicate the rotation frequency for a recipe after he makes the recipe for the first time. Representative screen interface 1000 may also prompt the user to specify when rotation should be applied (e.g., year-round, only during certain seasons, etc.). In addition, representative screen interface 1000 may identify other recipes in a user's personal collection which may go well with a dish selected by the user. For example, recipes for side dishes that go well with a “center of plate” dish may be identified to the user.

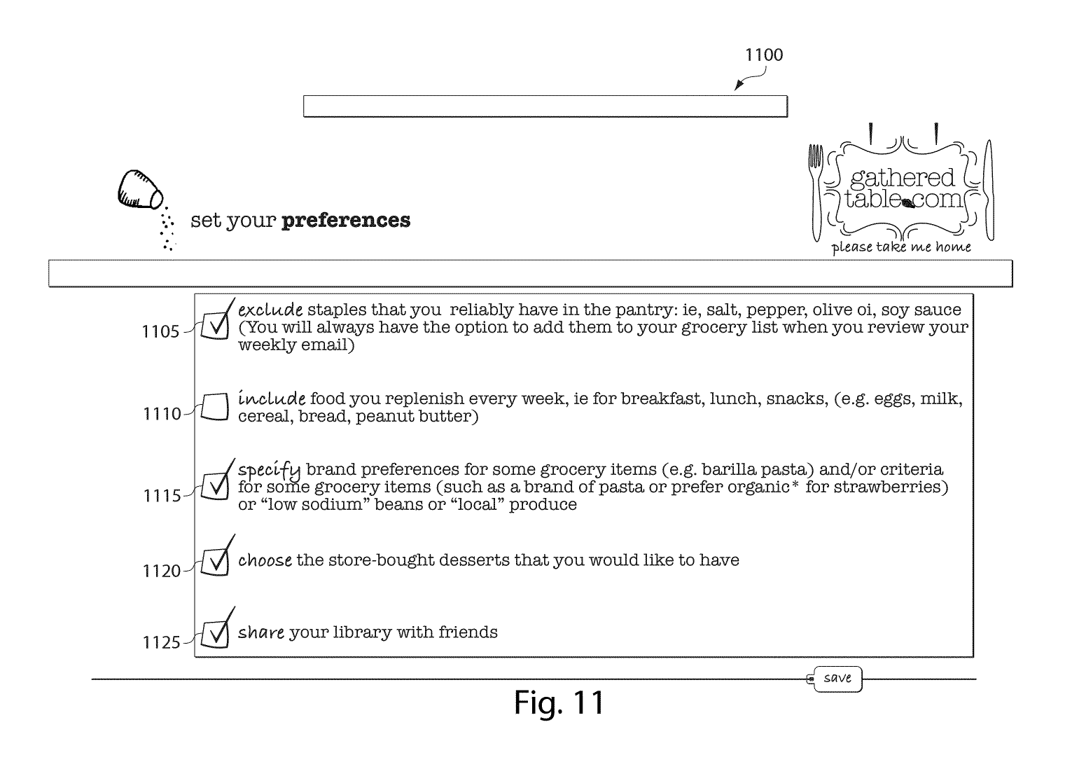

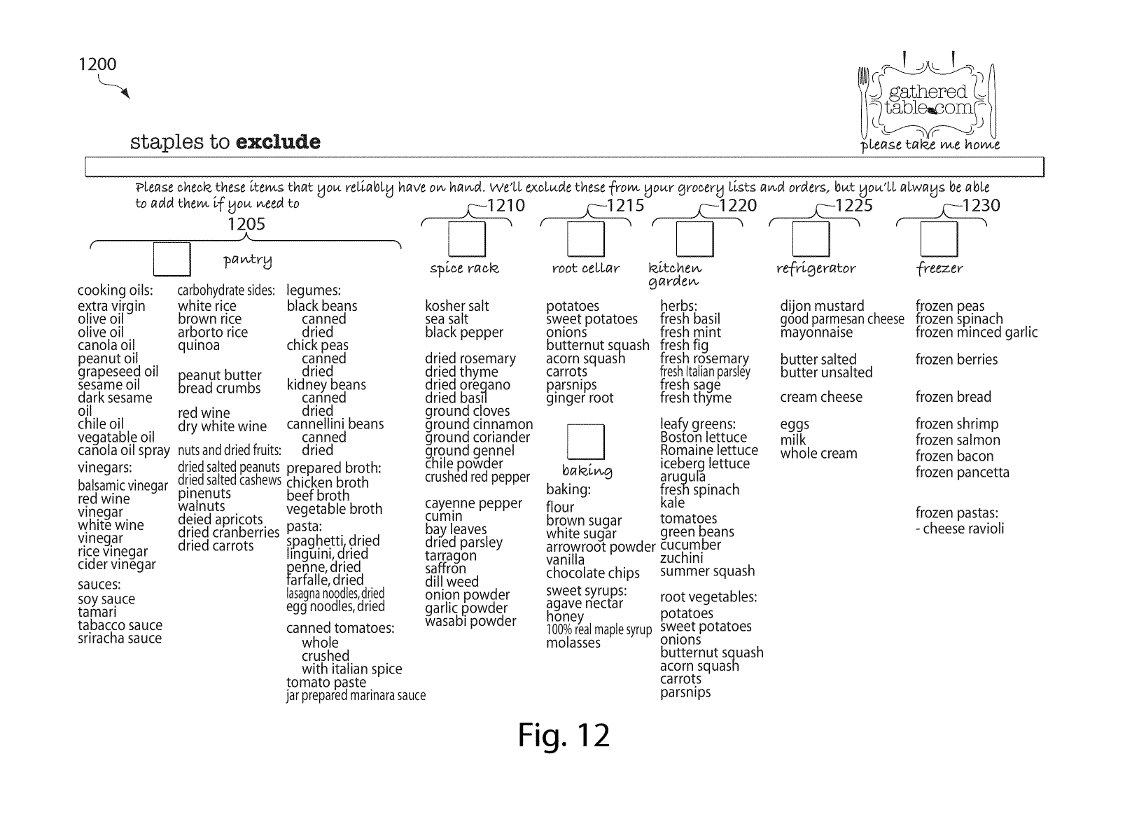

FIGS. 11-13 depicts representative screen interfaces 1100, 1200 and 1300 which allow the user to specify various preferences. Turning first to FIG. 11, representative screen interface 1100 includes facility 1105, which allows the user to specify that a grocery list should exclude staples which the user has in his/her pantry; facility 1110, which allows the user to indicate that his grocery list should include food which he replenishes every week; facility 1115, which allows the user to indicate that expressed preferences for certain grocery items should be obeyed; facility 1120, which allows the user to indicate that he wishes to select store-bought desserts to be included in meal plans; and facility 1125, which allows the user to indicate that his recipe library should be shared with friends. With respect to facility 1115, it should be appreciated that a user may specify any suitable preferences. For example, the user may express a preference for certain brands of particular grocery items, for items having certain nutritional content (e.g., no high fructose corn syrup, low sodium, low fat, etc.), for items having a particular location of origin (e.g., only locally grown produce, etc.), and/or for items having any other suitable trait(s). Such trait(s) may be flexibly defined. As one example, the user may express a preference with respect to organic items by specifying, for example, that only organic items should be included in recipes in the user's meal plan, that organic items should be used if available (so that, for example, the organic version of an item is preferred but if that version is unavailable, a non-organic version is acceptable), that organic items should only be used if they are within a specified percentage of the price of their conventional counterparts (so that, for example, the organic version of an item is used only if its price is no more than thirty percent greater than the price of the conventional version), and/or that conventional items are preferred. Any suitable manner of expressing preferences for items having one or more traits may be employed. Representative screen interface 1200, shown in FIG. 12, allows the user to identify items which are to be excluded from an automatically generated grocery list. For example, display area 1205 shows items commonly found in a user's pantry, display area 1210 shows items commonly found in a user's spice rack, display area 1215 shows items commonly found in a user's root cellar, display area 1220 shows items commonly found in a user's kitchen garden, display area 1225 shows items commonly found in a user's refrigerator, and display area 1230 shows items commonly found in a user's freezer. In some embodiments of the invention, a user may indicate that an item is to be excluded from a grocery list by clicking on a radio button associated with the item, as is well-known in the art. Of course, any suitable technique and/or technology may be employed.

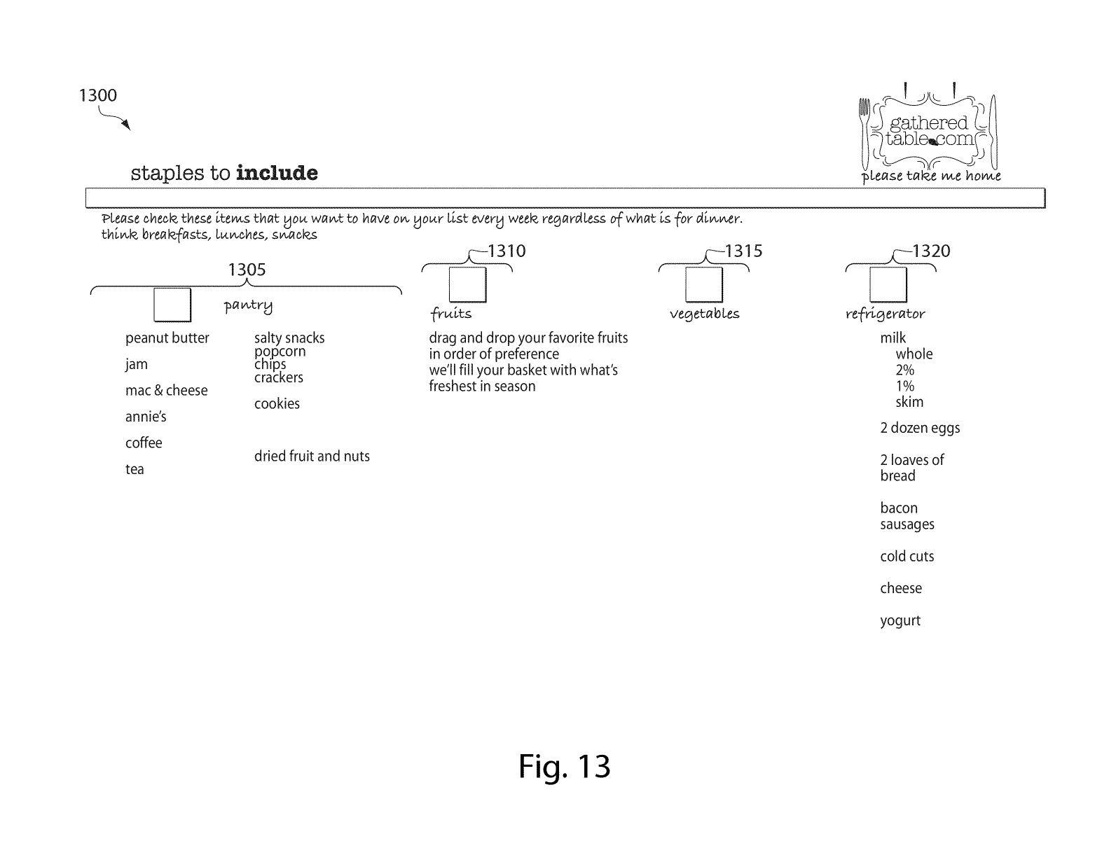

Representative screen interface 1300, shown in FIG. 13, allows the user to identify items which are to be included in a grocery list, despite their not being called for by a meal plan generated for the user. Display area 1305 shows common pantry items, display area 1310 shows types of fruit, display area 1315 shows types of vegetables, and display area 1320 shows common refrigerated items. It should be appreciated that by enabling the user to include items in a grocery list which are not specifically called for in a meal plan, embodiments of the invention may allow the user to forego traveling to the grocery store at all, even for items not included or accounted for in a generated meal plan, potentially saving the user considerable time and effort.

It should be appreciated that embodiments of the invention are not limited to capturing only the specific types of user input described above with reference to FIGS. 1-13. Any suitable information, which may or may not relate to a user's goals, preferences and/or personal recipe collection, may be received from a user, as embodiments of the invention are not limited in this respect.

It should also be appreciated that in some embodiments of the invention, the information presented on representative screen interfaces 1100, 1200 or 1300 may account for information supplied via integration with the user's community supported agriculture (CSA) program membership. For example, representative screen interface 1200 may include a facility which enables the user to exclude from a grocery list items which the programs makes available to the user in his CSA basket.

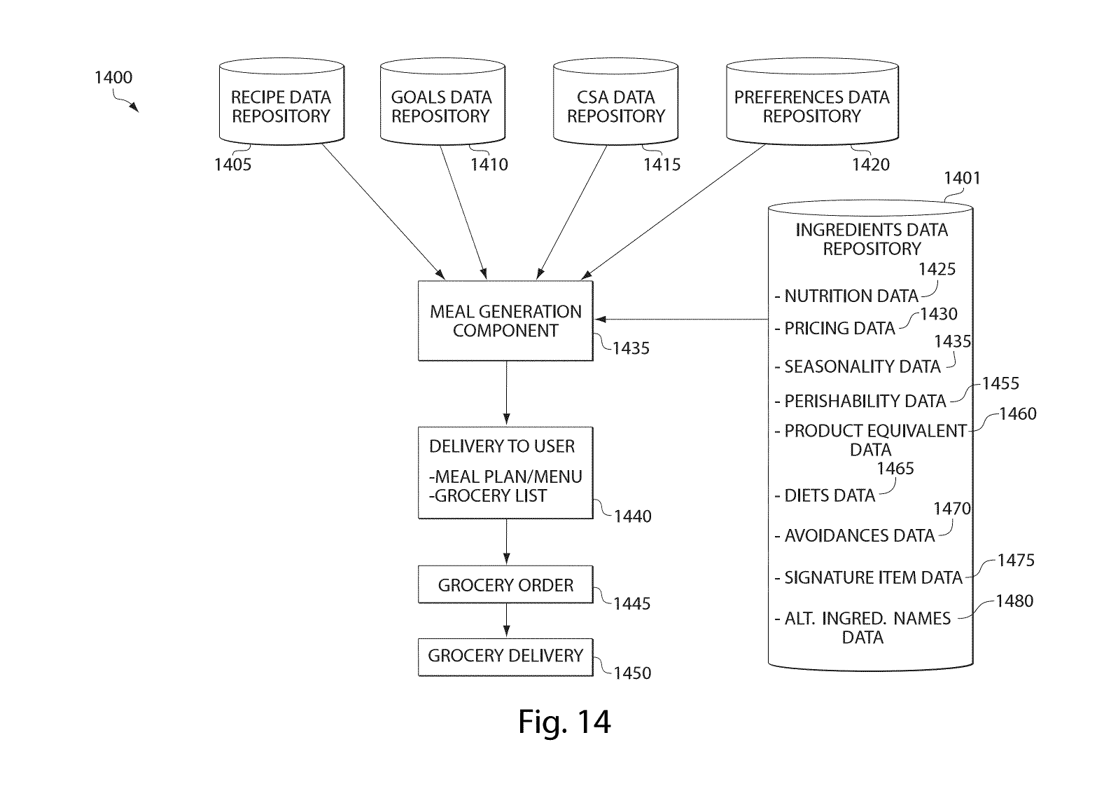

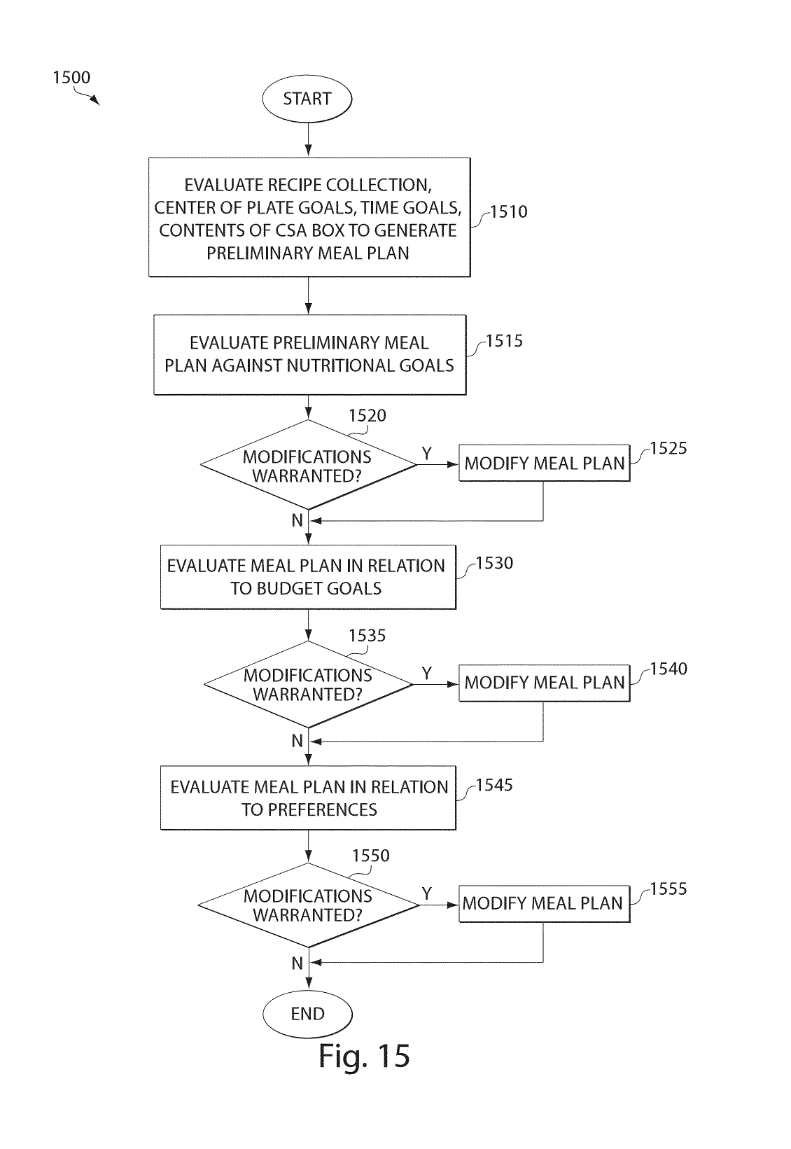

FIGS. 14-15 depict a representative system and representative technique, respectively, for generating a meal plan for a user. Turning first to FIG. 14, representative system 1400 includes ingredients data repository 1401, recipe data repository 1405, goals data repository 1410, C SA data repository 1415, and preferences data repository 1420. It should be appreciated that although repositories 1401-1420 are depicted in FIG. 14 as being physically separate, embodiments of the invention are not limited to being implemented in this manner. For example, in some embodiments, these repositories may each comprise one or more tables in a single database which stores all of the information used in the generation of meal plans. In other embodiments, multiple databases may be employed, each storing the data encompassed by one or more of repositories 1401-1420. Embodiments of the invention are not limited to any particular mode of implementation.

In some embodiments of the invention, each of repositories 1405-1420 may be populated, at least in part, with data supplied by users. For example, recipe data repository 1405 may store information supplied by users via representative screen interface 700 (FIG. 7), goals data repository 1410 may store information supplied by users via representative screen interfaces 200, 300, 400, 500 and 600 (FIGS. 2, 3, 4, 5, and 6, respectively), and preferences data repository 1420 may store information supplied by users via representative screen interfaces 1100, 1200 and 1300 (FIGS. 11, 12 and 13, respectively). Recipe data repository 1405 may store information on users' personal recipe collections, as well as information on “starter” recipe libraries made available to all users. Goals data repository 1410 may store information supplied by users relating to nutritional goals, dietary needs, avoidances, time available, budget, center of plate content and format, and meal elements. Preferences data repository 1420 may store such information as users' expressed preferences, items which are to be excluded from and included in users' grocery lists, and expressed brand preferences. CSA data repository 1415 may store information on contents of users' CSA baskets, thereby allowing recipes to be selected which utilize those items. Each of repositories 1405-1420 may be updated manually and/or automatically.

By contrast, in some embodiments of the invention, ingredients data repository 1401 may be populated, at least in part, with data that is not supplied by users. For example, ingredients data repository 1401 may store information on ingredients that may be used to determine, for example, labels used in selecting or identifying recipes. In the example shown in FIG. 14, the information on ingredients includes nutrition data 1425, pricing data 1430, seasonality data 1436, perishability data 1455, product equivalents data 1460, diets data 1465, avoidances data 1470, signature item data 1475 and alternative ingredient names data 1480. However, it should be appreciated that some embodiments of the invention may not employ the specific types of data shown in FIG. 14. For example, some embodiments may employ additional types of ingredients data, and others may not employ all of the data types shown in FIG. 14.

Nutrition data 1425 may, for example, include nutritional information relating to recipes and/or ingredients, including amounts of protein, fat, calories, sugar, fiber and other information in the recipes and/or ingredients. Pricing data 1430 may, for example, include store price information on food items which may be included in recipes provided in meal plans. Seasonality data 1436 may, for example, include indications when some items (e.g., types of produce) are in season (so that, for example, asparagus may be labeled a “spring” vegetable), and may be used to determine whether recipes that call for those items are in season (so that, for example, recipes which call for asparagus are labeled “spring” recipes). Perishability data 1455 may, for example, include indications as to how quickly certain items spoil (e.g., indications that fresh herbs spoil within a few days, but potatoes may last several weeks before spoiling), which may inform meal plan generation component 1435 (described in further detail below) how quickly the items should be used in a recipe to prevent them from becoming spoiled beforehand (so that, for example, meal plan generation component 1435 may schedule recipes that include fresh herbs within a few days of them being purchased).

Product equivalents data 1460 may, for example, include information useful for converting commonly-used recipe measurement quantities (e.g., a “head” of lettuce, a “sprig” of parsley, a teaspoon of sugar, etc.) to weight and/or volume measurements used by grocers (so that, for example, a half cup of chopped carrot called for a recipe can be converted to the whole carrot unit sold by grocers). Product equivalents data 1460 may also, for example, include information useful for determining the number of servings of particular items in the main dish of a meal, so that the appropriate number of side dishes may be included in the meal to complement that main dish. As a result, if the user has indicated a desire to have two vegetable servings with each meal, the main dish for a particular meal is chicken pot pie, product equivalents data 1460 may be useful in determining that the chicken pot pie recipe calls for the equivalent of a serving of carrots for each person eating the meal, so that only one vegetable side dish should be included in the meal rather than two.

Diets data 1465 may, for example, include information indicating whether particular ingredients and/or items are appropriate for particular diets. For example, diet data 1465 may indicate that meat-based ingredients are appropriate for omnivore diets, but not for vegan diets, that carbohydrate-based ingredients are appropriate for vegetarian diets but not paleo diets, etc. Any suitable relationship between ingredients or items and diet types may be specified.

Avoidances data 1470 may, for example, define associations between particular ingredients and user-defined avoidances. For example, avoidances data 1470 may define an association between gluten and gluten avoidances, so that recipes which call for ingredients that contain gluten (e.g., pasta, bread, cookies, etc.) may be excluded from recommendations made to users who have indicated a desire for a gluten-free diet. Any suitable association between ingredients and avoidances may be defined.

Signature item data 1475 may, for example, associate particular ingredients with particular “center of plate” formats. For example, a user may indicate a desire to have a “beef” center of plate dish at least once per week. As such, signature item data 1475 may associate ingredients such as ground beef, chuck roast, strip steak, etc. with the label “beef,” enabling meal plan generation component 1435 to satisfy the user's expressed preference by including at least one dish which includes one of the associated ingredients in a meal plan for each week.

Alternative ingredient names data 1480 may, for example, associate multiple names for particular ingredients, such as names for the ingredients in multiple languages, or other commonly used synonyms. For example, alternative ingredient names data 1480 may associate miring with rice wine, green onions with scallions, etc., indicating that these are alternative names for the same ingredient.

In representative system 1400, meal plan generation component 1435 comprises executable code which takes information stored in data repositories 1401-1420 (e.g., as described in the paragraphs above) as input, and produces (among other information) meal plans and grocery lists for users as output. However, it should be appreciated that the business logic used to generate meal plans need not be realized via software, and that embodiments of the invention may be implemented using hardware, software, or a combination thereof. Further, it should be appreciated that although meal plan generation component 1435 is depicted in FIG. 14 as a single component, embodiments of the invention are not limited to such an implementation. For example, meal plan generation component 1435 may comprise a plurality of sub-components, which may be distributed, logically and/or physically, to accomplish any of numerous implementation objectives. For example, in a client-server or web architecture, some sub-components of meal plan generation component 1435 may reside on the server side, and some may reside on the client side. Any of numerous modes of implementation are possible.

The output generated by meal plan generation component 1435 may include a user's meal plan. A meal plan may be assembled by meal plan generation component 1435 in any of numerous ways, based on any of numerous factors, including but not limited to the nutrition goals, dietary needs, avoidances and meal-building considerations expressed by the user via the representative screen interface 300 (FIG. 3) and preferences expressed by the user via the representative screen interface 1100 (FIG. 11). One example of an additional factor that may be considered in developing a meal plan is how well certain dishes “go together.” The extent to which dishes go together may be specified manually by a user, and/or defined automatically by the system. As one example, the user may indicate that beef and potato dishes go together by indicating that a potato-based dish should be included in meals which also include a beef dish. As another example, meal plan generation component 1435 may apply logic specifying that dishes having certain characteristics do not go well together. For example, programmed logic forming part of meal plan generation component 1435 may specify that dishes which include Mexican spices do not go well together with dishes which include Italian spices, so that a given meal does not include one dish made with Italian spices and another dish made with Mexican spices. Dishes may be associated as going well together, or not going well together, in any of numerous ways.

Another factor that may be considered in developing a meal plan for a user is the kitchen equipment to which the user has access. In this respect, some embodiments of the invention may provide a facility which allows the user to specify a kitchen equipment inventory, and may use this information in developing meal plans for the user. For example, if the user specifies that he owns a slow cooker, Panini maker, and/or other less-commonly owned equipment, then recipes which involve use of this equipment may be included in a meal plan developed for the user. As another example, if the user specifies that he owns one oven only, then a meal plan created for the user may not include a plurality of dishes in the same meal which are to be baked at different temperatures.

A generated meal plan may be delivered to the user, as represented in FIG. 14 at 1440. Delivery may be accomplished using any suitable tools and/or techniques. In some embodiments, delivery may be performed electronically (e.g., via email, text, and/or using any other suitable delivery mechanism(s), which may be specified by the user), although embodiments of the invention are not limited to such an implementation. Further, delivery may be occur at a time and/or periodicity specified by the user. For example, a user may specify that an email including his meal plan be delivered by 8 AM each Saturday morning, because he knows that delivery at that time will allow him to devote his attention to reviewing it.

In some embodiments, a meal plan and/or grocery list may be delivered in a manner which provides the user with access to editing tools. For example, an e-mail which includes a meal plan for the coming week may include a hyperlink which the user may click to access a web page that allows the user to edit the meal plan. Further, a meal plan may be delivered in a manner which allows the user to approve it. For example, an e-mail which includes a meal plan may include a hyperlink which the user may click to approve the meal plan.

Once the user approves a meal plan, a corresponding grocery list may be generated, as represented in FIG. 14 at 1440. The grocery list may, for example, serve as the basis for a delivery order which is submitted to a grocery supplier, as represented in FIG. 14 at 1445, so that groceries on the list may be delivered to the user, as represented at 1450. Some embodiments of the invention enable the user to specify when grocery delivery is to occur, so that he can make arrangements to meet the delivery person at the appointed time. Of course, embodiments of the invention are not limited to having groceries delivered to users. For example, a grocery list may be delivered to a user (e.g., via email, text, etc.) once he approves a corresponding meal plan, so that he may shop for ingredients called for by the meal plan.

Some embodiments may provide a capability to deliver meal plans to users (and/or other designated individuals) in the form of electronic calendar entries. This capability may allow a user that plans a family's meals for the week to inform each family member what is being served for dinner each night, which may provide guidance to those family members on what to eat earlier in the day (e.g., so as to not eat the same thing for lunch as is planned for dinner). Additionally or alternatively, some embodiments may provide the capability to automatically print hard copies of recipes included in a meal plan, so that the user need not have a computer open in the kitchen while he cooks.

FIG. 15 depicts a representative process 1500 for generating a meal plan for a user. Representative process 1500 may be performed, for example, by meal plan generation component 1435 (FIG. 14), using information stored in one or more of repositories 1401-1420, and/or other information.

At the start of representative process 1500, a user's personal recipe collection, center of plate content and format goals, time goals, and CSA box contents are analyzed to produce a preliminary meal plan in act 1510. This may be performed in any of numerous ways. In some embodiments, recipes in the user's personal recipe collection which satisfy the user's center of plate content and format goals and time goals, and which utilize at least one item in the user's CSA box, are selected to comprise the preliminary meal plan.

Representative process 1500 then proceeds to act 1515, wherein the preliminary meal plan is evaluated against the user's expressed nutrition goals. This also may be performed in any of numerous ways. For example, act 1515 may comprise a determination whether the preliminary meal plan would allow the user to satisfy his expressed nutritional goals.

Representative process 1500 then proceeds to act 1520, wherein a determination is made whether modifications to the preliminary meal plan are warranted. If it is determined that modifications are warranted, then the process proceeds to act 1525, wherein modifications are made. This may be performed in any suitable fashion. For example, in some embodiments, recipes in the preliminary meal plan which do not allow the user to meet his nutritional goals may be swapped for other recipes that do.

At the completion of act 1525, or if it is determined in act 1520 that modifications to the preliminary meal plan are not warranted, representative process 1500 proceeds to act 1530, wherein the current meal plan (i.e., as generated in act 1510, or as modified in act 1525) is evaluated against the user's expressed budget goals. This also may be performed in any of numerous ways. For example, act 1530 may comprise determining whether the total cost of the meals included in the current meal plan exceeds the meal budget specified by the user.

Representative process 1500 then proceeds to act 1535, wherein a determination is made whether modifications to the current meal plan are warranted. If it is determined that modifications are warranted (e.g., because the current meal plan would not allow the user to meet his budget goals), then the process proceeds to act 1540, wherein modifications are made. This may be performed in any suitable way. For example, in some embodiments, one or more recipes in the current meal plan may be swapped for other, less expensive recipes with similar ingredients, so that the total cost of the meals included in the meal plan do not exceed the user's meal budget.

At the completion of act 1540, or if it is determined in act 1535 that modifications to the preliminary meal plan are not warranted, representative process 1500 proceeds to act 1545, wherein the current meal plan (i.e., as generated in act 1530, or as modified in act 1540) is evaluated against the user's expressed preferences. This, too, may be performed in any of numerous ways. For example, act 1545 may entail determining whether the meals included in the current meal plan satisfy the user's expressed preferences with regard to desserts, brand-name ingredients, etc.

Representative process 1500 then proceeds to act 1550, wherein a determination is made whether modifications to the current meal plan are warranted. If it is determined that modifications are warranted (e.g., because the current meal plan does not satisfy the user's preferences), then the process proceeds to act 1555, wherein modifications are made. This may be performed in any suitable fashion. For example, in some embodiments, one or more recipes in the current meal plan may be swapped for other recipes which allow the user's preferences to be satisfied. At the completion of act 1555, or if it is determined in act 1550 that modifications to the preliminary meal plan are not warranted, representative process 1500 ends.

It should be appreciated that representative process 1500 represents merely one example of a process for generating a meal plan for a user, and that numerous variations are possible. For example, a process for generating a meal plan in accordance with embodiments of the invention may include acts not described above with reference to FIG. 15, may not include all of the acts described above with reference to FIG. 15, and/or may include the acts described above being performed in a different sequence than that which is shown in FIG. 15.

For example, some embodiments of the invention may, in performing one or more of the acts described with reference to FIG. 15, also give consideration to whether any of the recipes included in a meal plan call for perishable items, and if so, may select additional recipes for the same meal plan which also use the same perishable item, so that it may be completely consumed before it spoils. Any of numerous variations on representative process 1500 are possible.

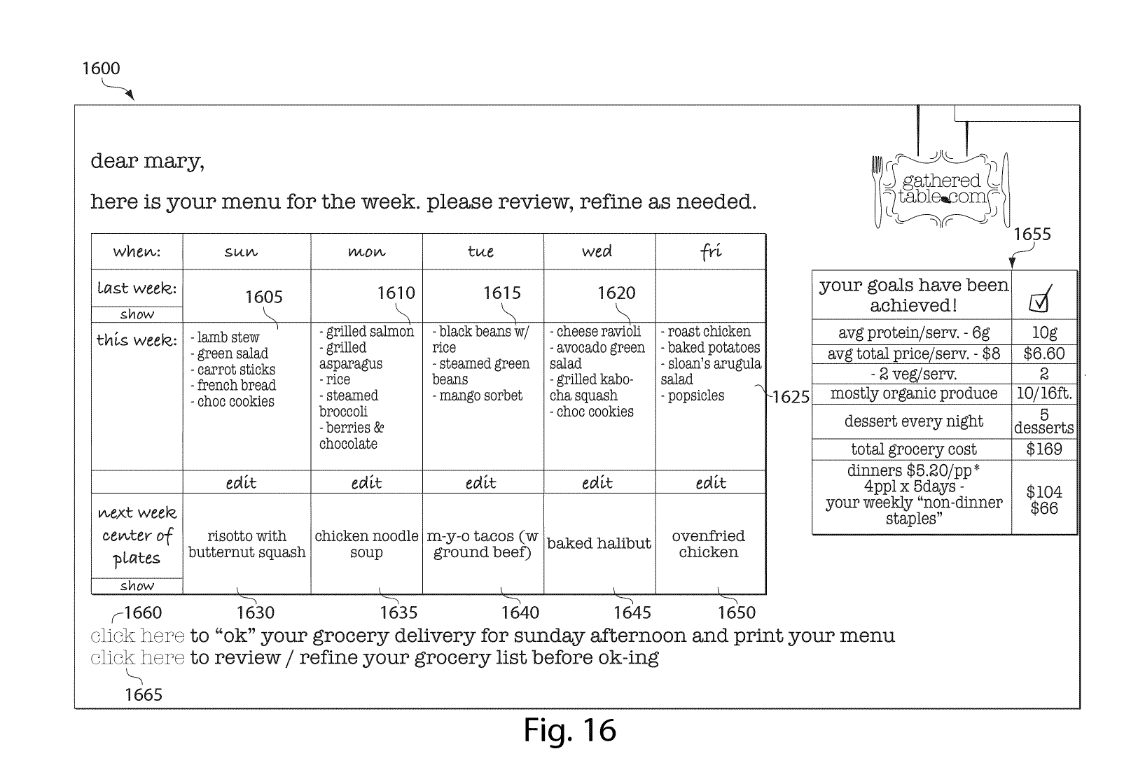

FIG. 16 depicts a representative screen interface 1600 for displaying a meal plan to a user. In the example shown, the user has elected to have a meal plan which includes meals to be prepared on Sunday, Monday, Tuesday, Wednesday and Friday, and so the meal plan shown includes proposed meals for those days, as shown in display areas 1605, 1610, 1615, 1620 and 1625, respectively. Representative screen interface 1600 also displays the “center of plate” dishes for Sunday, Monday, Tuesday, Wednesday and Friday of the following week, at display areas 1630, 1635, 1640, 1645 and 1650, respectively, to give the user a preview of the plan for that week.

Representative screen interface 1600 may enable a user to modify a meal plan, in any of numerous ways. For example, the user may move meals, or dishes in a meal, from one night to another. As an example, if the user changes his mind and decides to cook on Thursday instead of Wednesday of the week shown, then the user may move Wednesday's planned meal to Friday (e.g., by clicking on display area 1620 and “dragging” it toward display area 1625, by providing voice input indicating that Friday's meal should be replaced by Wednesday's meal, and/or providing any other suitable form of input). The user may also delete entire meals. As an example, if the user changes his mind and decides not to cook on Wednesday of the week shown, then the user may delete Wednesday's planned meal entirely, using any suitable form of input provided in any suitable manner.

Representative screen interface 1600 may enable the user to manually define the menu for a day, collection of days (e.g., a weekend), a week, and/or any other suitable time period. For example, the user may wish to manually create a menu for a special event (e.g., a family reunion to take place over a long weekend). To do so, the user may, for example, specify recipes from his/her collection which are to be prepared on certain days (e.g., by “dragging and dropping” the recipes from the collection on to the days, using a facility not shown in FIG. 16, and/or via any other suitable form(s) of input). By allowing the user to define portions of meal plans manually, some embodiments of the invention provide flexibility and control over the meal plan definition process, while still retaining the benefits of automatically defining other portions of the meal plan to satisfy his/her objectives and expressed preferences.

Representative screen interface 1600 may also enable a user to add, remove or replace items in a meal. As an example, the user may replace the “Sloan's Arugula Salad” shown as part of Friday's dinner with “Caesar Salad,” using any suitable form of input to signal the replacement. To identify items to add to a meal, some embodiments of the invention may enable users to search their personal recipe collection and/or a database of items. Users may also search for recipes to include in a meal plan. As an example, in response to receiving salmon from their neighbor who just went fishing, a user may search for recipes which include salmon.

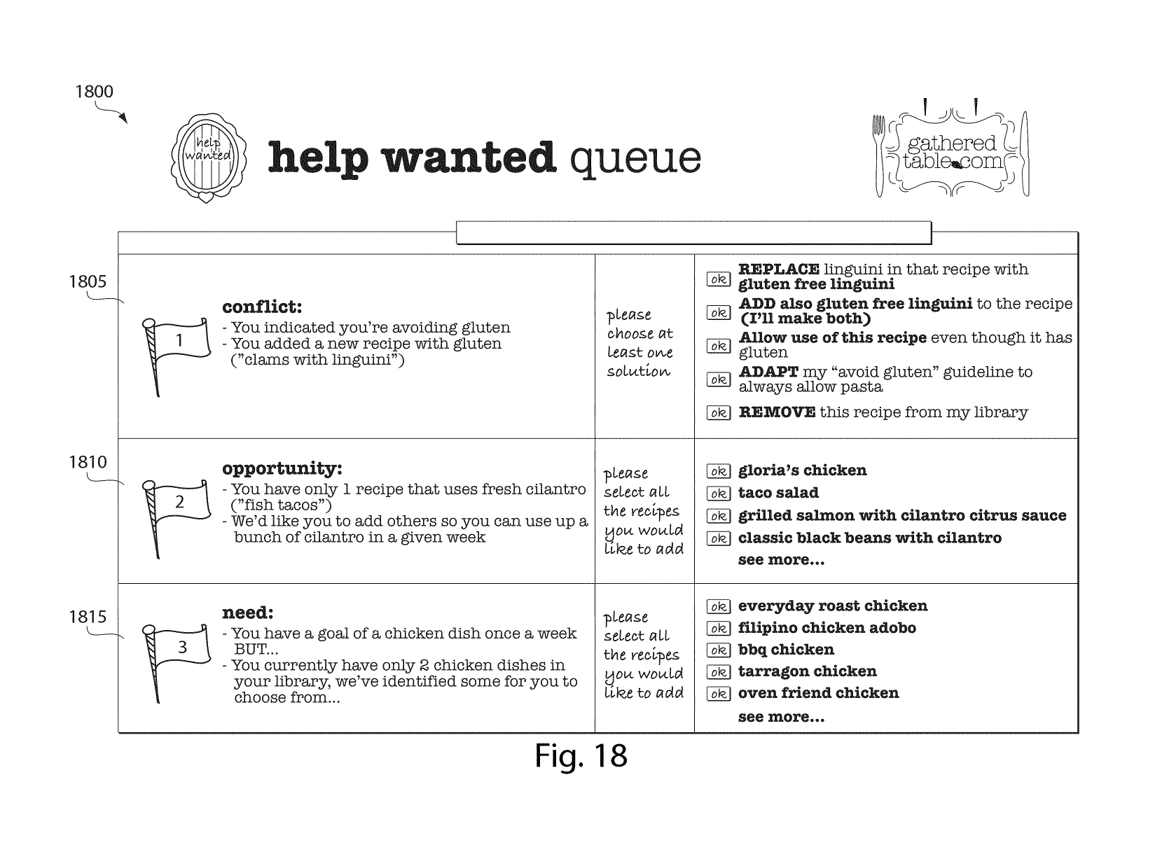

In some embodiments of the invention, when a user makes a change to a meal plan which causes the meal plan to no longer satisfy their expressed goals and/or preferences (e.g., by manually specifying meals to be prepared during certain days, as described above, which do not satisfy those goals/preferences), then he may be prompted to approve the modified meal plan, or to indicate that a revised meal plan should be generated. FIG. 18, described below, depicts a tool which allows a user to resolve issues which arise, for example, because of inconsistencies between different sets of information supplied by a user.

Display area 1655 includes information indicating that certain of the user's goals and/or preferences have been satisfied. In the example shown, these goals/preferences include “avg. protein/serv.˜6g,” “avg. total price/serv.˜$8,” “˜2 veg./serv.,” “mostly organic produce,” “dessert every night,” and “total grocery cost.” In addition, the user is informed that the “total grocer cost” of $169 includes $104 for dinner items and $65 for “non-dinner staples.” Of course, any suitable information may be shown, to indicate that a user's goals and/or preferences are satisfied by a meal plan of for other reasons, as the invention is not limited to any particular manner of implementation.

Although not shown in FIG. 16, some embodiments of the invention may enable a user to edit the menu shown in representative screen interface 1600 so as to encompass a more comprehensive plan that includes all meals, not just those defined by the system. For example, some embodiments may allow the user to edit the menu shown in representative screen interface 1600 to include days other than those that are shown (e.g., to add Thursdays and Saturdays to the example shown in FIG. 16), and to supply input to indicate the family's dinner plans for the added day(s). For example, the user may indicate that the family's plans for an added day are to go to a party, eat at a restaurant, eat dinner at a grandparent's house, etc. A more comprehensive plan created in this manner may, for example, be printed and posted to keep members of a family informed of the family's plans for all days, and not just those days for which meals are defined by the system.

The inventor has appreciated that some users may not have large personal recipe collections, such as when they first begin using the system. As such, some of the recipes used to make meals and/or dishes in a particular user's meal plan may come from other recipe collections (e.g., a “starter collection,” as described above, and/or any other suitable collection(s)). In some embodiments of the invention, a meal plan may visually indicate to the user the source of the recipes used to make meals reflected in the plan. For example, a meal plan may indicate that certain meals are made using recipes from the user's personal collection, certain meals are made using recipes from other collections, and some are made using a combination of recipes from the user's personal collection and other collections (e.g., a meal may include an entree made using a recipe in the user's collection and a side dish made using a recipe from another collection). Any suitable technique may be used to visually indicate the source of a recipe. For example, in some embodiments, meals and/or dishes may be color-coded to indicate the recipe source.

Further, in some embodiments of the invention, recipes from other collections which are used to make meals and/or dishes in a user's meal plan may be automatically added to the user's personal recipe collection when the user approves the meal plan. As a result, the user's personal recipe collection may be built up over time with minimal time and effort on the user's part.

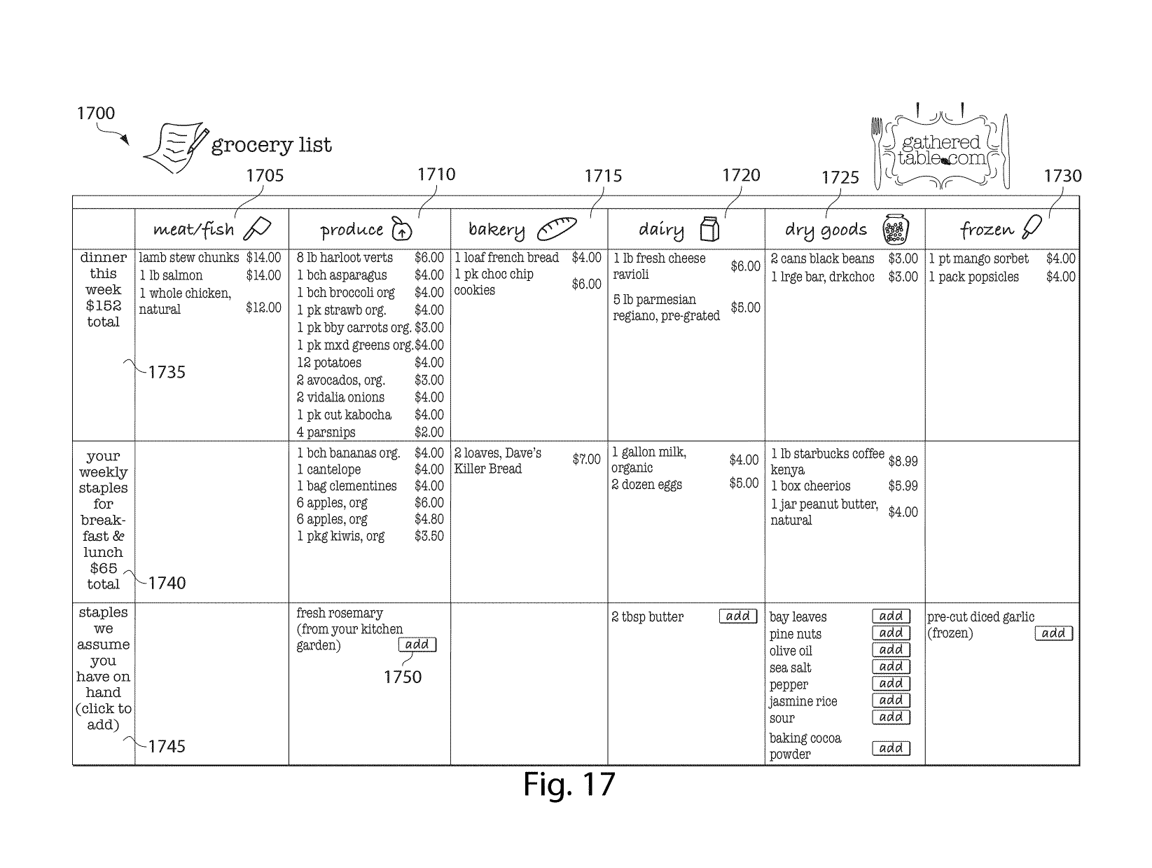

FIG. 17 depicts representative screen interface 1700 for displaying a grocery list corresponding to a meal plan to a user. In the example shown, the grocery list is displayed in the form of a matrix, with row 1735 showing items that are ingredients in recipes in the user's meal plan for a week, row 1740 showing other items which the user has indicated should be included in the grocery list, and row 1745 showing items which are assumed to be on hand at the user's home. Column 1705 includes meat/fish items, column 1710 includes produce items, column 1715 includes bakery items, column 1720 includes dairy items, column 1725 includes dry goods items and column 1730 includes frozen items. Thus, as an example, the cell in row 1735 (showing items to be included in the week's meal plan) and column 1705 (showing meat/fish items) indicates meat/fish items included in the week's meal plan. Representative screen interface 1700 enables the user to edit the grocery list, such as to add items assumed to be on hand (i.e., shown in row 1745) to the items to be purchased (e.g., shown in row 1735). For example, by clicking link 1750, the user may add “fresh rosemary” to the produce items shown in row 1735 and column 1710.

Some embodiments of the invention may deduce what items the user has on hand, based on knowledge of the size of those items that were purchased, and of how much was used over time in making recipes included in meal plans. As such, some embodiments may suggest additions to a user's grocery list based on an inference that the user may be running low on certain items.

Representative screen interface 1800, shown in FIG. 18, provides a tool that allows the user to resolve issues which arise as a result of information he provides. In the example shown, possible resolutions for each conflict are identified for the user. For example, row 1805 indicates that the user has previously expressed a goal to avoid gluten, but also added a recipe to his/her collection which includes gluten (“clams with linguini”). The user is prompted to take one of the five actions listed to resolve the conflict, including replacing the linguini in the recipe with gluten-free linguini, adding gluten-free linguini in addition to non-gluten-free linguini to the recipe, allowing use of the recipe even though it has gluten, adapting the user's guideline to always allow pasta even if it contains gluten, and removing the recipe from the user's library. Row 1810 indicates that the user's recipe collection includes only one recipe that uses fresh cilantro, so that if a bunch of cilantro is purchased, not all of the cilantro will be used by the end of the week, and some will go wasted. As such, the user is prompted to add recipes which call for cilantro to his personal recipe collection. Row 1815 indicates that the user has specified a goal of eating a chicken dish once a week, but has only two chicken dishes in his personal collection, and so the user is prompted to select chicken recipes to add to his collection. Any suitable issue may be addressed, in any suitable way, as embodiments of the invention are not limited in this respect.

It should be appreciated that although much of the description above relates to the generation of meal plans for families, embodiments of the invention are not limited in this respect. For example, some embodiments of the invention may be used to generate meal plans for a single individual, or for a group of individuals that do not constitute a family (e.g., roommates in an apartment). Embodiments of the invention may be used to generate meal plans for any one or more individuals.

It should also be appreciated that although much of the description above relates to the preparation of the dinner meal, embodiments of the invention are not so limited. For example, meal plans may account for breakfast, lunch, snacks, and/or any other food consumption event. For example, embodiments of the invention could be used to plan lunches and mid-afternoon snacks for children at a day-care center, to ensure that the children are fed healthy foods at those times. Numerous uses for the invention are possible.

It should further be appreciated that the functionality described above may constitute only a subset of the functionality that is provided by a system implemented in accordance with embodiments of the invention. For example, some embodiments of the invention provide a capability to send reminders to users, in advance of certain meals being prepared, to perform particular shopping- or preparation-related tasks. For example, a reminder may be sent to a user to pick up fresh fish, marinate certain ingredients, take items out of the freezer to defrost, etc., in advance of a particular meal being prepared. Further, some embodiments of the invention may provide a capability to analyze the preparation technique(s) called for by a recipe, and send reminders related to the technique(s) as appropriate. For example, if it is determined that a recipe calls for ingredients to be baked (e.g., based on an analysis of words in the recipe), then a reminder may be sent to preheat the oven prior to beginning preparation of the meal. Reminders may be delivered in any suitable fashion (e.g., electronically, such as via email, text message, etc.).

Some embodiments of the invention provide a capability to inform a user when certain items in his pantry should be replenished. For example, some embodiments of the invention may provide a capability to compare quantities of an item used in recipes included in a meal plan to quantities of the item that have been purchased by the user, and recommend that the item be replenished when the user's supply of that item appears low. Using an example to illustrate, programmed logic may specify that two tablespoons of olive oil equals one fluid ounce, and it may be known (e.g., based on prior grocery orders) that a user last purchased a thirty-two ounce bottle of olive oil on a certain date. When the total amount of olive oil consumed in preparing meals in a meal plan after that date approaches thirty-two ounces, the user may be informed that he should replenish his olive oil supply.

Some embodiments of the invention enable users to print paper copies of various information described above, such as meal plans or menus, grocery lists, and recipes, including any picture(s) included in the recipes. Additionally, some embodiments of the invention may enable the user to print any or all of the recipes in his collection in a bound volume suitable for gift-giving or passing along to family or friends.

Some embodiments of the invention allow users to grant access to the information which is used to generate meal plans for them. For example, a user may grant access to his nutrition goals, preferences, recipe library, etc., to a partner, parent, child, nutritionist, personal shopper, personal trainer, brand ambassador/concierge, and/or any other suitable party.

Some embodiments of the invention provide users with access to curated recipe collections, such as collections curated by celebrities or other persons of note. For example, some embodiments may allow a user to purchase access to such collections, and to specify that the proceeds from the purchase should be donated to a non-profit (e.g., chosen by the respective celebrity or person of note).

Some embodiments of the invention may analyze kitchen equipment inventory specified by the user to recommend additional equipment for purchase. For example, recipes indicated by the user as favorites may be analyzed to identify similar recipes which require equipment which the user does not yet own, and a recommendation to the user to purchase the additional equipment may indicate the additional recipes which the user might be able to prepare with the new equipment.

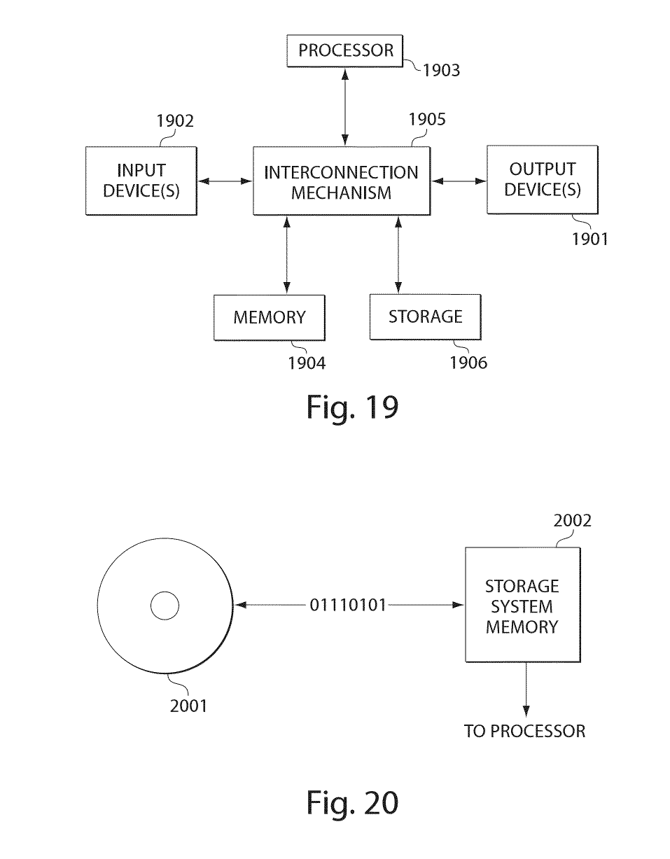

Various aspects of the systems and methods for practicing features of the invention may be implemented using one or more computer systems, such as the representative computer system 1900 shown in FIG. 19. Computer system 1900 includes input devices 1902, output devices 1901, processor 1903, memory system 1904 and storage 1906, all of which are coupled, directly or indirectly, via interconnection mechanism 1905, which may comprise one or more buses, switches, networks and/or any other suitable interconnection. The input devices 1902 receive input from a user or machine (e.g., a human operator, or telephone receiver), and the output devices 1901 display or transmit information to a user or machine (e.g., a liquid crystal display). The processor 1903 typically executes a computer program called an operating system (e.g., a Microsoft Windows (R)-family operating system or other suitable operating system) which controls the execution of other computer programs, and provides scheduling, input/output and other device control, accounting, compilation, storage assignment, data management, memory management, communication and data flow control. Collectively, the processor and operating system define the computer platform for which application programs in other computer programming languages are written.

The processor 1903 may also execute one or more computer programs to implement various functions. These computer programs may be written in any type of computer programming language, including a procedural programming language, object-oriented programming language, macro language, or combination thereof. These computer programs may be stored in storage system 1906. Storage system 1906 may hold information on a volatile or nonvolatile medium, and may be fixed or removable. Storage system 1906 is shown in greater detail in FIG. 20.

Storage system 1906 typically includes a computer-readable and writeable nonvolatile recording medium 2001, on which signals are stored that define a computer program or information to be used by the program. The medium may, for example, be a disk or flash memory. Typically, in operation, the processor 1903 causes data to be read from the nonvolatile recording medium 2001 into a volatile memory 2002 (e.g., a random access memory, or RAM) that allows for faster access to the information by the processor 1903 than does the medium 2001. This memory 2002 may be located in storage system 1906, as shown in FIG. 19, or in memory system 2004, as shown in FIG. 20. The processor 1903 generally manipulates the data within the integrated circuit memory 1904, 2002 and then copies the data to the medium 2001 after processing is completed. A variety of mechanisms are known for managing data movement between the medium 2001 and the integrated circuit memory element 1904, 2002, and the invention is not limited thereto. The invention is also not limited to a particular memory system 2004 or storage system 1906.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface including keyboards, and pointing devices, such as mice, touch pads, and digitizing tables. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A computer system for generating a meal plan for a user, the meal plan specifying a plurality of meals to be prepared by or for the user over a period of time, each of the plurality of meals comprising a center of plate dish and at least one side dish, the computer system comprising:
at least one processor programmed to;
receive input from the user defining at least one of:
a frequency at which a recipe favored by the user is to be used to prepare a meal in the meal plan;
an amount to be spent on ingredients for at least one meal in the meal plan;
an ingredient to be included in the center of plate dish for at least one meal in the meal plan;
a manner of preparing the center of plate dish for at least one meal in the meal plan;
a number of vegetable servings, a number of carbohydrate servings, and whether a dessert is included, in at least one meal in the meal plan;
one or more items made available to the user by a community supported agriculture program to which the user belongs;
generate a meal plan for the user based at least in part on the received input; and
cause the generated meal plan to be presented to the user.

2. The computer system of claim 1, wherein the at least one processor is programmed to receive input defining a collection of recipes for the user, and to generate the meal plan to include meals prepared using the recipes in the collection.

3. The computer system of claim 1, wherein the at least one processor is programmed to generate a shopping list comprising items included in meals in the meal plan.

4. The computer system of claim 1, wherein the at least one processor is programmed to receive input on nutrition goals, dietary needs, and/or dietary avoidances of the user.

5. The computer system of claim 1, wherein the at least one processor is programmed to receive input specifying a number of nights per week meals in the meal plan are to be prepared by the user.

6. The computer system of claim 1, wherein the at least one processor is programmed to receive input specifying an amount of time the user can devote to hands-on tasks associated with preparing a meal in the meal plan.

7. The computer system of claim 1, wherein the at least one processor is programmed to receive input on kitchen equipment that the user has on hand, and to generate the meal plan to include only recipes which can be prepared using the kitchen equipment which the user has on hand.

8. The computer system of claim 1, wherein the at least one processor is programmed to cause the generated meal plan to be presented to the user at a time specified by the user.

9. At least one computer-readable storage device having instructions recorded thereon which, when executed by a computer, cause the computer to perform a method for generating a meal plan for a user, the meal plan specifying a plurality of meals to be prepared by or for the user over a period of time, each of the plurality of meals comprising a center of plate dish and at least one side dish, the method comprising acts of:
(A) receiving input from the user defining at least one of:
a frequency at which a recipe favored by the user is to be used to prepare a meal in the meal plan;
an amount to be spent on ingredients for at least one meal in the meal plan;
an ingredient to be included in the center of plate dish for at least one meal in the meal plan;
a manner of preparing the center of plate dish for at least one meal in the meal plan;
a number of vegetable servings, a number of carbohydrate servings, and whether a dessert is included, in at least one meal in the meal plan;
one or more items made available to the user by a community supported agriculture program to which the user belongs;
(B) generating a meal plan for the user based at least in part on the received input; and
(C) causing the generated meal plan to be presented to the user.

10. The at least one computer-readable storage device of claim 9, wherein the act (A) comprises receiving input defining a collection of recipes for the user, and the act (B) comprises generating the meal plan to include meals prepared using the recipes in the collection.

11. The at least one computer-readable storage device of claim 9, wherein the act (B) comprises generating a shopping list comprising items included in meals in the meal plan.

12. The at least one computer-readable storage device of claim 9, wherein the act (A) comprises receiving input on nutrition goals, dietary needs, and/or dietary avoidances of the user.

13. The at least one computer-readable storage device of claim 9, wherein the act (A) comprises receiving input specifying a number of nights per week meals in the meal plan are to be prepared by the user.

14. The at least one computer-readable storage device of claim 9, wherein the act (A) comprises receiving input specifying an amount of time the user can devote to hands-on tasks associated with preparing a meal in the meal plan.

15. The at least one computer-readable storage device of claim 9, wherein the act (A) comprises receiving input on kitchen equipment that the user has on hand, and the act (B) comprises generating the meal plan to include only recipes which can be prepared using the kitchen equipment which the user has on hand.

16. The at least one computer-readable storage device of claim 9, wherein the act (C) comprises causing the generated meal plan to be presented to the user at a time specified by the user.

17. A computer system for generating a meal plan for a user, the meal plan specifying a plurality of meals to be prepared by or for the user over a period of time, the computer system comprising:
at least one processor programmed to;
receive input from the user defining a collection of recipes favored by the user;
receive input, from the user, specifying a frequency at which a recipe which is not in the collection is to be used to prepare a meal included in the meal plan; and
generate a meal plan for the user based at least in part on the input received from the user.

18. A computer system for generating a meal plan for a user, the meal plan specifying a plurality of meals to be prepared by or for the user over a period of time, the computer system comprising:
at least one processor programmed to;
receive input from the user specifying one or more recipes favored by the user and a plurality of desired attributes of meals included in the meal plan;
identify a conflict between (1) one of the plurality of desired attributes and (2) either another of the plurality of desired attributes, or the specified recipes; and
cause the user to be prompted to supply input to resolve the conflict.

19. At least one computer-readable storage device having instructions recorded thereon which, when executed by a computer, cause the computer to perform a method for generating a meal plan for a user, the meal plan specifying a plurality of meals to be prepared by or for the user over a period of time, the method comprising acts of:
(A) receiving input from the user defining a collection of recipes favored by the user;
(B) receiving input, from the user specifying a frequency at which a recipe which is not in the collection is to be used to prepare a meal included in the meal plan; and
(C) generating a meal plan for the user based at least in part on the input received from the user.

20. At least one computer-readable storage device having instructions recorded thereon which, when executed by a computer, cause the computer to perform a method for generating a meal plan for a user, the meal plan specifying a plurality of meals to be prepared by or for the user over a period of time, the method comprising acts of:
(A) receiving input from the user specifying one or more recipes favored by the user and a plurality of desired attributes of meals included in the meal plan;
(B) identifying a conflict between (1) one of the plurality of desired attributes and (2) either another of the plurality of desired attributes, or the specified recipes; and
(C) causing the user to be prompted to supply input to resolve the conflict.
